(19) United States
(12) Patent Application Publication
(10) Pub. No.: US 2008/0091690 A1
(43) Pub. Date: Apr. 17, 2008

(54) Deriving a Data Model From a Hierarchy Of Related Terms, And Deriving a Hierarchy Of Related Terms From a Data Model

(75) Inventors: Raymond Ellersick, San Jose, CA (US); Mary Ann Roth, San Jose, CA (US)

Correspondence Address: INTERNATIONAL BUSINESS MACHINES CORP., IP LAW, 555 BAILEY AVENUE, J46/G4, SAN JOSE, CA, 95141, US

(73) Assignee: INTERNATIONAL BUSINESS MACHINES CORPORATION, Armonk, NY (US)

(21) Appl. No.: 11/549,556

(22) Filed: Oct. 13, 2006

(51) Int. Cl. G06F 7/00

(52) U.S. Cl. 707/100

(57) ABSTRACT

Various embodiments of a method, system and computer program product generate a data model based on a glossary model. The glossary model comprises categories and terms. At least one category of the glossary model comprises at least one term of the terms. The categories have a hierarchical relationship. The categories are mapped to objects of a data model. The terms are mapped to attributes of the data model. The attributes are associated with the objects of the data model, wherein a particular attribute of the attributes is associated with a particular object of the objects that is mapped from a particular category of the categories that comprises a particular term of the terms from which the particular attribute is mapped. The objects are associated in a hierarchical relationship based on the hierarchical relationship of the categories. In other embodiments, a method, system and computer program product generate a glossary model based on a data model.

### BACKGROUND OF THE INVENTION

1. Field of the Invention

This invention relates to a data model; and in particular, this invention relates to deriving a data model from a hierarchy of related terms, and deriving a hierarchy of related terms from a data model.

2. Description of the Related Art

Data models, a particular kind of object model, are used to represent the information produced and/or consumed by software. The task of creating a data model is often a collaboration between a business analyst and a data architect. A business analyst is a person who understands the business context for which the data model is to be built, and plays the role of communicating business requirements to the technical staff. A data architect is a person on the technical staff who is highly skilled in data modeling. The data architect understands the alternatives for representing information, and the advantages and disadvantages associated with each of the alternatives.

The collaboration to create and implement a data model that captures the information that is required for the business application is often difficult and error prone because the collaborators have different skill sets and they approach the problem from different perspectives. The business analyst is most interested in establishing business context so as to produce the information required to enable and support business decisions, while the data architect is looking to provide the most efficient data model implementation possible given the semantics of the information and the constraints and restrictions imposed by the software to implement the data model. In addition, the collaborators use different tools. A business analyst might use a spreadsheet or Microsoft Word document to list business terms, their definitions and relationship to one another, or, alternatively, a tool such as IBM® (Registered Trademark of International Business Machines Corporation) WebSphere® (Registered Trademark of International Business Machines Corporation) Business Glossary that additionally allows them to group their business terms into categories of related terms, and to relate their business terms to existing physical data assets, such as database tables and columns. The data architect, on the other hand, may use a sophisticated modeling tool, such as Rational® (Registered Trademark of International Business Machines Corporation) Data Architect or ERwin® (Registered Trademark of CA International, Inc.) Data Modeler.

The translation between the business terms from a spreadsheet or a Word document or software tool to the components of a data model is a mostly manual process today, and quite cumbersome for a large number of terms or complex data models. An import tool can be used to automatically load the data modeling tool with the list of terms, usually with a loss of information, such as how terms are arranged in categories. In addition, the business analyst and data architect may share information verbally, or not at all. The lack of integration between their tools introduces many degrees of freedom in the design process that typically slows down the collaboration process. For example, because the collaborators may both “start from scratch” using their respective tools, it may be difficult for each collaborator to get started. In addition, the lack of integration between the tools used by the business analyst and data architect often introduces many steps into the collaboration process to reconcile their work.

Therefore there is a need for an improved technique for automating collaboration between the business analyst and data architect. This technique should derive a data model from a list of business terms. There is also a need for a technique to derive a list of business terms from a data model.

### SUMMARY OF THE INVENTION

To overcome the limitations in the prior art described above, and to overcome other limitations that will become apparent upon reading and understanding the present specification, various embodiments of a method, data processing system and computer program product generate a data model based on a glossary model. The glossary model comprises categories and terms. At least one category of the glossary model comprises at least one term of the terms. The categories have a hierarchical relationship. The categories are mapped to objects of a data model. The terms are mapped to attributes of the data model. The attributes are associated with the objects of the data model, wherein a particular attribute of the attributes is associated with a particular object of the objects that is mapped from a particular category of the categories that comprises a particular term of the terms from which the particular attribute is mapped. The objects are associated in a hierarchical relationship based on the hierarchical relationship of the categories.

In some embodiments, a computer program product comprises a computer usable medium having computer usable program code for generating a data model based on a glossary model. The glossary model comprises categories and terms, and at least one category of the glossary model comprises at least one term of the terms. The categories have a hierarchical relationship. The computer program product includes: computer usable program code for mapping the categories to objects of a data model; computer usable program code for mapping the terms to attributes of the data model; computer usable program code for associating the attributes with the objects of the data model, wherein a particular attribute of the attributes is associated with a particular object of the objects that is mapped from a particular category of the categories that comprises a particular term of the terms from which the particular attribute is mapped; and computer usable program code for associating the objects in a hierarchical relationship based on the hierarchical relationship of the categories.

In other embodiments, a method, system and computer program product generate a glossary model based on a data model. The data model comprises objects and attributes. The attributes are associated with the objects. The objects have a hierarchical relationship. The objects are mapped to categories. The terms are mapped to attributes. The categories are associated in a hierarchical relationship based on the hierarchical relationship of the objects. Each term of the terms is associated with at least one category of the categories based on the at least one object of the objects from which the at least one category is mapped comprising the attribute from which the term is mapped.

In this way, an improved technique for automating collaboration between the business analyst and data architect is provided. In various embodiments, a data model is derived from a list of business terms. In other embodiments, a list of business terms is derived from a data model.

### BRIEF DESCRIPTION OF THE DRAWINGS

The teachings of the present invention can be readily understood by considering the following description in conjunction with the accompanying drawings, in which:

FIG. 1 depicts an exemplary set of business terms for insurance claim information;

FIG. 2A graphically depicts an exemplary data model that is based on the set of business terms of FIG. 1;

FIG. 2B graphically depicts three domains that are associated with the domain types of FIG. 2A;

FIG. 3 depicts an illustrative diagram which shows the package of the exemplary data model of FIG. 2A;

FIG. 4 depicts an illustrative glossary-to-data-model mapping table;

FIG. 5 depicts an illustrative relationship mapping table depicting the mapping of three cases of the third glossary-to-data-model mapping rule of the glossary-to-data-model mapping table of FIG. 4;

FIG. 6 depicts an illustrative mapping of a portion of an exemplary glossary model representing a portion of the glossary of FIG. 1 to a portion of an exemplary data model based on various rules of the glossary-to-data-model mapping table of FIG. 4 and the relationship mapping table of FIG. 5;

FIG. 7 depicts another portion of the exemplary glossary model representing the glossary of FIG. 1;

FIG. 8 depicts another portion of the exemplary data model which is generated based on the glossary model of FIG. 7;

FIG. 9 depicts a flowchart of an embodiment of generating a data model from a glossary model;

FIG. 10 depicts a flowchart of another embodiment of generating a data model from a glossary model;

FIG. 11 depicts four exemplary entities with their exemplary attribute pair lists;

FIG. 12 depicts primary, alternate and foreign keys that are generated based on the entities and attribute pair lists of FIG. 11;

FIG. 13 illustrates various data structures which are associated with processing synonym groups;

FIG. 14 depicts an illustrative data-model-to-glossary-model mapping table depicting rules for mapping constructs of a data model to constructs of a glossary model;

FIG. 15 depicts a flowchart of an embodiment of generating a glossary model from a data model; and

FIG. 16 depicts an illustrative data processing system which uses various embodiments of the present invention.

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to automate collaboration between a business analyst and a data architect. Various embodiments of a method, data processing system and computer program product generate a data model based on a glossary model. The glossary model comprises categories and terms. At least one category of the glossary model comprises at least one term of the terms. The categories have a hierarchical relationship. The categories are mapped to objects of a data model. The terms are mapped to attributes of the data model. The attributes are associated with the objects of the data model, wherein a particular attribute of the attributes is associated with a particular object of the objects that is mapped from a particular category of the categories that comprises a particular term of the terms from which the particular attribute is mapped. The objects are associated in a hierarchical relationship based on the hierarchical relationship of the categories.

In some embodiments, a computer program product comprises a computer usable medium having computer usable program code for generating a data model based on a glossary model. The glossary model comprises categories and terms, and at least one category of the glossary model comprises at least one term of the terms. The categories have a hierarchical relationship. The computer program product includes: computer usable program code for mapping the categories to objects of a data model; computer usable program code for mapping the terms to attributes of the data model; computer usable program code for associating the attributes with the objects of the data model, wherein a particular attribute of the attributes is associated with a particular object of the objects that is mapped from a particular category of the categories that comprises a particular term of the terms from which the particular attribute is mapped; and computer usable program code for associating the objects in a hierarchical relationship based on the hierarchical relationship of the categories.

In other embodiments, a method, system and computer program product generate a glossary model based on a data model. The data model comprises objects and attributes. The attributes are associated with the objects. The objects have a hierarchical relationship. The objects are mapped to categories. The terms are mapped to attributes. The categories are associated in a hierarchical relationship based on the hierarchical relationship of the objects. Each term of the terms is associated with at least one category of the categories based on the at least one object of the objects from which the at least one category is mapped comprising the attribute from which the term is mapped.

In some embodiments, a computer program product comprises a computer usable medium having computer usable program code for generating a glossary model based on a data model. The data model comprises objects and attributes. The attributes are associated with the objects. The objects have a hierarchical relationship. The computer program product includes: computer usable program code for mapping the objects to categories of the glossary model; mapping the attributes to terms of the glossary model; associating the categories in a hierarchical relationship based on the hierarchical relationship of the objects; and associating each term of the terms with at least one category of the categories based on the at least one object of the objects from which the at least one category is mapped comprising the attribute from which the term is mapped. In some embodiments, the objects of the data model comprise at least one package and a plurality of entities.

In some embodiments, a data model is derived from business terms. In various embodiments, the business terms are analyzed, exploiting any categorization, synonyms and relationships provided to derive a data model. This data model can then be inspected, enhanced and modified by the data architect. In other embodiments, business terms are derived from a data model, and categories, relationships and synonyms of business terms are identified based on the relationships and objects of the data model. In some embodiments, the business terms are arranged in hierarchical categories based on the relationships of the data model.

In various embodiments, relationships in the data model are derived from hierarchical relationships among the categories of the glossary model and semantic relationships between the terms of the glossary model. In some embodiments, terms are determined to have a semantic relationship if they are synonyms, that is, if they belong to the same synonym group. In various embodiments, terms are determined to have a semantic relationship if one of the terms is a reference to another term in another category.

As organizations are increasingly subject to governmental regulations to govern and restrict access to information assets, consistency of information about those assets and their representation is increasingly important. Various embodiments of the present invention reduce the opportunity for different users with different skills and motivations to develop independent and autonomous representations of the same information by providing an automatic means to maintain consistency and collaboratively translate a common representation from one format to another.

In a relational database, data is stored in tables which have rows and columns, and various columns may be used to associate the tables with each other. A key is used to access particular rows of data in the table(s). A key specifies one or more columns. A primary key has one or more columns that, taken together, uniquely identify each row of a table. The primary key is used as the main key to access data of its table. A foreign key comprises one or more columns of a table that match one or more columns of a primary key of another table. A foreign key that partially matches a primary key of another table is also referred to as a partial foreign key. The foreign key can be used to cross-reference tables. An alternate key also comprises one or more columns that uniquely identify each row of a table, and is not designated as a primary key.

A data model is a particular kind of object model. In various embodiments, a data model describes a logical data structure of a data source. Examples of data sources include, and are not limited to, a database, a spreadsheet, a text file and an extensible Markup Language (XML) document. Some data models describe the logical structure of a data source using entities and relationships between the entities. One or more attributes that describe an entity may be associated with that entity. An entity-relationship diagram graphically represents the entities and their relationships, and in some embodiments, their attributes. In various embodiments, a graphical user interface displays the data model. In some embodiments in which the data source is a relational database, various database tools construct the relational database based on the data model.

Various embodiments of the present invention are generally applicable to model-driven architecture and object-oriented modeling techniques. The data model can be expressed with a variety of modeling paradigms, such as Unified Modeling Language (UML) or Entity-Relationship (E-R) modeling. In this description, E-R notation as described by Peter P. Chen, in “The Entity-Relationship Model—Toward a Unified View of Data,” ACM Transactions on Database Systems, Vol. 1, No. 1, March 1975, pages 9-35. However, the invention is not meant to be limited to a data model using the E-R paradigm and is applicable to other data models.

The Unified Modeling Language expresses a data model in terms of entities and relationships. An entity is an instance of an object, and in various embodiments, can be described by an entity type that distinguishes it from other objects. In various embodiments, “class” is used rather than entity type. In some embodiments, a package is an instance of an object. In various embodiments, an object may be an entity or a package. A “container object” refers to a package object and an entity object.

An attribute represents data that is associated with an entity, and more generally an object. An attribute is also an object. In various embodiments, the attribute comprises a name and an attribute type. An entity may have zero or more attributes. In various embodiments, attribute types comprise primitive types, a reference type, and a domain type. Examples of primitive types include and are not limited to integer (INTEGER), character (CHAR), variable length character (VARCHAR), decimal (DECIMAL), float (FLOAT) and date (DATE). The phrase “reference type” refers to a reference to another entity.

Domain types represent an abstract type. The domain type provides a way of providing a symbolic name to a data type. The domain type is typically a user-defined type. A domain type may optionally include all possible values for attributes of that type. In various embodiments, the present invention determines the attribute type based on the content of the glossary model.

Classes can be arranged in a hierarchy in which a subclass inherits all of the attributes of another type called the superclass. Entities can also be arranged in a hierarchy. A higher level entity is referred to as a generalization entity, and its associated lower level entity is referred to as a specialization entity. A specialization entity inherits all of the attributes of its generalization entity. A relationship represents an association, such as whether an entity contains another entity. In some embodiments, if one entity does not have a particular relationship with another entity, that particular relationship for that one entity is null. In various embodiments, relationships are named and described as part of an entity's class definition. Classes of a data model can be logically grouped into packages. Entities can also be logically grouped into packages.

In the data model, a key comprises one or more attributes that identify an instance of an entity. A key is also an object. In the data model, a primary key has one or more attributes that, taken together, uniquely identify the instances of the entity. The primary key is used as a main key to access the entity. In the data model, a foreign key comprises one or more attributes of an entity that match attributes of a primary key of another entity. The foreign key can be used to cross-reference entities. A partial key contains a subset, that is less than all, of the attributes of a multi-attribute key. An alternate key also comprises one or more attributes that uniquely identify instances of an entity, and is not designated as a primary key. A relationship object associates keys thereby indicating a relationship between keys; and the relationship object comprises two keys.

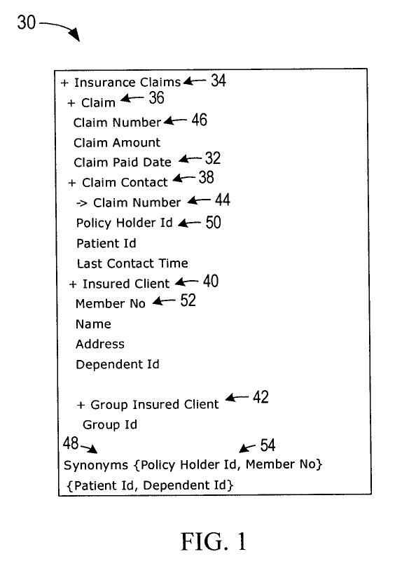

FIG. 1 depicts an exemplary set of business terms 30 for insurance claim information. The exemplary set of business terms 30 is an organized collection of terms, which is also referred to as a glossary. The glossary has a name, “Insurance Claims” 34. A term is made up of one or more words, such as “Claim Paid Date” 32. In some embodiments, the one or more words that make up a term are also referred to as the term name; and the term comprises the term name. In various embodiments related terms are grouped, and in some embodiments, contained, in categories, such as “Claim” 36, “Claim Contact” 38 and “Insured Client” 40. In various embodiments, categories are arranged into a hierarchy, for example, “Group Insured Client” 42 is a subcategory of the category called “Insured Client” 40. In FIG. 1, the glossary name, “Insurance Claims” 34 is indicated by a “+”, and the categories are indented and also indicated by a “+”. The amount of indentation indicates the hierarchical relationship. For example, the “Insured Client” category 40 is indented from “Insurance Claims” 34 thereby indicating that the “Insured Client” category 40 is a subcategory of “Insurance Claims” 34. The “Group Insured Client” category 42 also has a “+” and is positioned below and further indented with respect to the “Insured Client” category 40 thereby indicating that the Group Insured Client” category 42 is a subcategory of the “Insured Client” category 40.

In the glossary and glossary model, a term is contained in precisely one category, and may be referenced by one or more other categories. For example, in the “Claim Contact” category 38, the term “Claim Number” 44 is a reference to “Claim Number” 46 in the “Claim” category 36. The “→” preceding the term “Claim Number” 44 in the “Claim Contact” category 38 graphically indicates a reference to a term having that name in another category.

In this description, a term which belongs to a category may also be indicated as follows: “Category Name.Term”.

A synonym group 48 contains references to terms in one or more categories that have similar meaning. In this example, a “Policy Holder Id” and “Member No” are designated as synonyms in a synonym group, and “Patient Id” and “Dependent Id” are designated as synonyms in a synonym group.

The glossary is stored in a data structure that is referred to as a glossary model. The glossary model comprises categories, terms and relationships. In the glossary model, the categories, terms and synonym groups are also objects. The glossary model indicates various relationships between categories, between terms, and between a category and a term. For example, in the glossary model, glossary relationships indicate whether a category is a subcategory, what terms belong to a category, whether a category references a term in another category. In various embodiments, the glossary also defines synonym groups.

Although various embodiments are described with respect to “business terms”, the invention is not meant to be limited to “business terms” and other types of terms may be used.

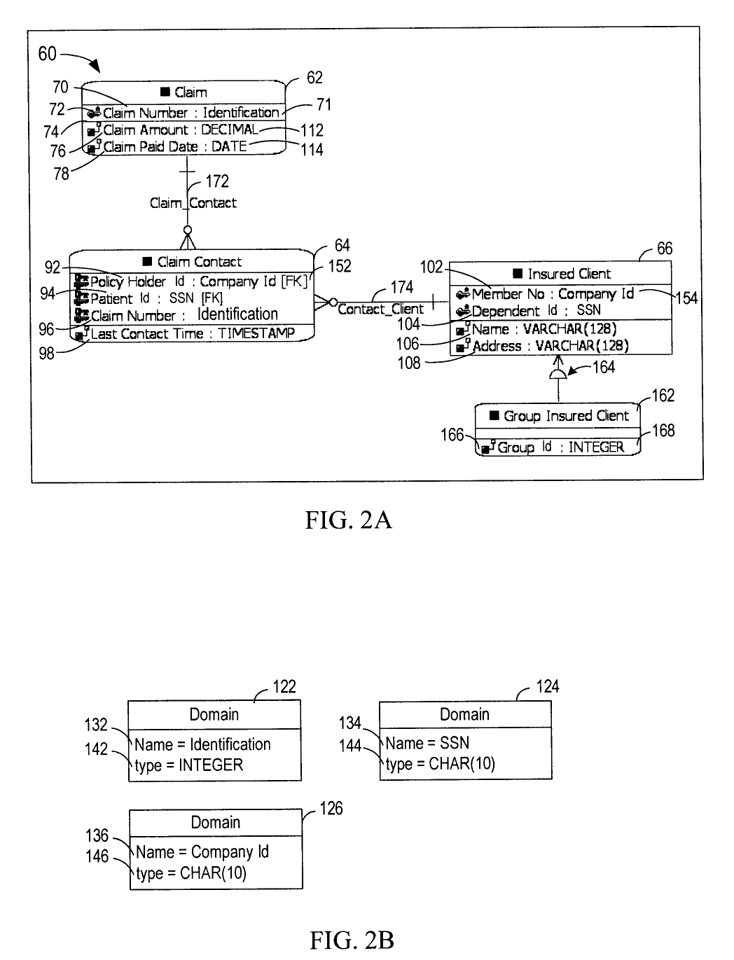

FIG. 2A graphically depicts an exemplary data model 60 based on the set of business terms of FIG. 1. In various embodiments, the exemplary data model 60 is displayed in a graphical user interface. This exemplary data model 60 is expressed in E-R notation. This data model 60 depicts three entities of a package that describes insurance claims. The entities are named “Claim” 62, “Claim Contact” 64, and “Insured Client” 66. In FIG. 2A, the package itself is not explicitly depicted. In this exemplary data model 60, the name of the package is “Insurance Claims”. The entities 62, 64, 66 and 162 have attributes. For example, the “Claim” entity 62 has an attribute named “Claim Number” 70 with an attribute type of “Identification” 71. In FIG. 2A, the attribute name and the attribute type are separated by a colon “:”. The attribute name is to the left of the colon and the attribute type is to the right of the colon. An attribute may also be referred to with the name of its entity in a form such as “Entity Name.Attribute Name”. For example, the “Claim Number” attribute 70 of the “Claim” entity 62 is also referred to as “Claim.Claim Number”. A key comprises one or more attributes, and the key can uniquely identify an instance of an entity. For example, “Claim.Claim Number” 70 is an attribute that is also designated as a key as indicated by the key symbol 72. In this example, “Claim.Claim Number” 70 is a primary key, and can be used to identify an instance of the “Claim” entity 62. Attributes above the line 74, such as “Claim Number” 70, are part of the primary key, and attributes below the line 74 are not part of the primary key. The “Claim” entity 62 also comprises the “Claim Amount” and “Claim Paid Date” attributes 76 and 78, respectively.

The “Claim Contact” entity 64 comprises the “Policy Holder Id”, “Patient Id”, “Claim Number” and “Last Contact Time” attributes, 92, 94, 96 and 98, respectively. A primary key of the “Claim Contact” entity 64 comprises the “Policy Holder Id”, “Patient Id” and “Claim Number” attributes, 92, 94 and 96, respectively,

The “Insured Client” entity 66 comprises the “Member No”, “Dependent Id”, “Name” and “Address” attributes, 102, 104, 106 and 108, respectively. A primary key of the “Insured Client” entity 66 comprises the “Member No” and “Dependent Id” attributes 102 and 104, respectively.

Referring also to FIG. 2B, three domains 122, 124 and 126 that are associated with the domain types of FIG. 2A are shown. In some embodiments, the domains are also shown in the same graphical user interface with the data model 60 of FIG. 2A. A domain is an entity and has a name and a type. A domain is also an object. In this example, the data model 60 has three domains 122, 124 and 126, with a name of “Identification”, “SSN” and “Company Id”, 132, 134 and 136, with a type of INTEGER, CHAR and CHAR(10), 142, 144 and 146, respectively. “Claim Contact.Policy Holder Id” 92 and “Insured Client.Member” 102 both have an attribute type of “Company Id”, 152 and 154. In another example, “Claim.Claim Number” 70 has an attribute type of “Identification” 71.

The “Group Insured Client” entity 162 has a specialization relationship with the “Insured Client” entity 66, as indicated by the line and symbol 164. Thus the “Insured Client” entity 66 is a generalization entity, and the “Group Insured Client” entity 162 is a specialization entity. The “Group Insured Client” entity 162 has an attribute named “Group Id” 166 with an attribute type of integer 168.

The “Claim” entity 62 and “Claim Contact” entity 64 have a relationship based on “Claim Number”, and that relationship is indicated by line 172 and the relationship has a name of “Claim_Contact”. The relationship between the “Claim” entity 62 and “Claim Contact” entity 64 is based on the reference to “Claim Number” in the “Claim Contact” category. The “Claim Contact” entity 64 and the “Insured Client” entity 66 have a relationship as indicated by line 174 and the relationship name is “Contact_Client”. The relationship between the Claim Contact entity 64 and the Insured Client entity is based on the synomym groups such that “Claim Contact.Policy Holder Id” is a synonym of “Insured Client.Member No” and “Claim Contact. Patient Id” is a synomyn of “Insured Client.Dependent Id”.

In various embodiments, the attribute type of the data model is determined based on the attribute name. A pattern list contains a list of patterns and an associated type for each pattern. For example, the pattern list has a pattern called “amt” which is associated with a type of integer. If the attribute name of an attribute contains “amt”, the pattern list is searched for “amt”, a match is found, the associated type of integer is retrieved, and the attribute type is determined to be integer. In various embodiments, if a portion of an attribute name comprises a pattern, a match is found. In another example, if the attribute name is “books-amt”, a match is found for “amt” in the pattern list, the associated type of integer is retrieved, and the attribute type is determined to be integer.

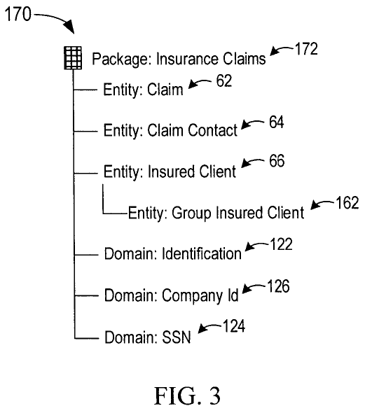

FIG. 3 depicts an illustrative diagram 170 which shows the package of the exemplary data model 170 of FIG. 2A. The package 172 is named “Insurance Claims”. The package 172 comprises the “Claim”, “Claim Contact” and Insured Client” entities 62, 64 and 66, respectively. The “Insured Client” entity 64 has a specialization entity, the “Group Insured Client” entity 162. The package 172 also comprises the “Identification”, “Company Id” and “SSN” domains, 122, 126 and 124, respectively.

The strategy that is used to organize the glossary represents semantic meaning that is imposed by the glossary's author, and various embodiments of the present invention automatically generate a data model that captures the semantic meaning represented by the terms. In addition, the structure of the data model designed by the data architect represents an organizational strategy for the glossary, and some embodiments of the present invention automatically generate a glossary model based on that organizational strategy.

Various embodiments of deriving a data model from a glossary model by analyzing the content of the glossary model and applying a set of rules that govern how components of the glossary model are mapped or transformed to components of a data model will be described.

FIG. 4 depicts an illustrative glossary-to-data-model mapping table 190. The glossary-to-data-model mapping table illustrates various rules for mapping a glossary model to a data model. The glossary-to-data-model mapping table 190 has a glossary model column 192 and a data model column 194. In various embodiments, the rules of the glossary-to-data-model mapping table 190 of FIG. 4 are implemented in a glossary-to-data-model transformation module. In various embodiments, the glossary-to-data-model transformation module maps the categories of the glossary model to packages and entities of the data model, and maps the terms of the categories to attributes of associated entities.

In various embodiments, in the glossary model, each category has a “Category.containsTerm” list which contains all the terms of the category. In the data model, each entity is associated with an “Entity.hasAttribute” list which contains the attributes that are associated with the entity. In general, a category is mapped to an entity in such a way that terms in the Category.containsTerm list are mapped to attributes in an Entity.hasAttribute list of the entity. In addition, a subcategory of the glossary model is mapped to a specialization entity of the data model.

A first glossary-to-data-model mapping rule 202 maps a category (Category) of the glossary model to either an entity (Entity) or package (Package) of a data model. The “1” in the circle to the left indicates the first glossary-to-data-model mapping rule 202. If a category contains zero or more subcategories and the category itself and all of its direct and indirect supercategories, if any, do not contain any terms, that category is mapped to a package; otherwise the category is mapped to an entity. Therefore, if a category has at least one term, that category is mapped to an entity. Also, for example, if a category does not contain any terms and has no subcategory and no supercategories, that category is mapped to a package. In another example, if a category contains no terms and all of its direct and indirect supercategories, if any, do not contain any terms, that category is mapped to a package. The motivation for the first glossary-to-data-model mapping rule is based on an observation of reasons that a business analyst may choose to define a hierarchical structure of categories. One reason is that a subcategory defines terms that constitute a specialization of its supercategory. Therefore an entity is generated, and will subsequently be determined to be a specialization entity. Another reason may be that the supercategory is used as a convenient way of organizing two or more subcategories that have related but non-overlapping terms. For example, the “Insurance Claims” category of FIG. 1 is a supercategory that is used to group the “Claim”, “Claim Contact” and “Insured Client” categories. In this example, the mapping of the supercategory “Insurance Claims” to a package is desirable. In various embodiments, a category that does not contain any terms is determined to be used for organizational purposes, and that category is mapped to a package of the data model.

A second glossary-to-data-model mapping rule 204 maps terms and their associated relationship to their categories of the glossary model to the data model. The “2” in the circle to the left indicates the second glossary-to-data-model mapping rule 204. Each term 206 in the glossary model is mapped to an attribute 208 in the data model. In various embodiments, the glossary model has a “Category.containsTerm” relationship 210 which indicates that the category contains at least one term. For example, the “Category.containsTerm” relationship 210 may be determined based on whether the “Category.containsTerm” list has at least one attribute for the category. Each attribute is mapped to, that is, associated with, the entity that represents the category in which the term is contained. The “has Attribute” relationship (“Entity.hasAttribute”) 212 of the entity is updated to indicate that the entity contains the attribute(s).

A third glossary-to-data-model mapping rule 220 maps a “Category.hasSubcategory” glossary model relationship 222 to either an “Entity.hasSpecialization” 224 data model relationship or to “Package.hasContents” and “Package.hasChildren” data model relationships, 226 an 228, respectively. The “3” in the circle to the left indicates the third glossary-to-data-model mapping rule 206. In various embodiments, the glossary model comprises a hasSubcategory list for each category that has at least one Subcategory. The hasSubcategory list lists all the subcategories of a category.

In response to a category being in the hasSubcategory list of another category, the objects in the data model that correspond to those categories are associated in a manner that is appropriate to the type of object that is generated.

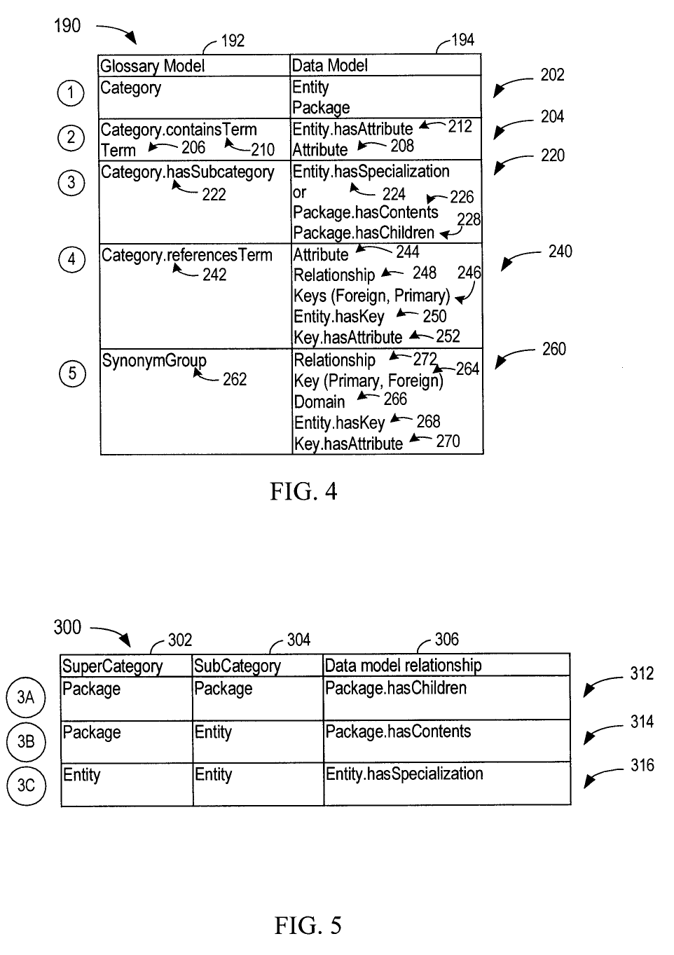

FIG. 5 depicts a relationship mapping table 300 showing the mapping of the three cases of the third glossary-to-data-model mapping rule 220. The table 300 has a SuperCategory column 302, a SubCategory column 304 and a Data model relationship column 306. In FIG. 5, a first supercategory-subcategory mapping rule 312 specifies that if a SuperCategory is mapped to a package and that SuperCategory has a SubCategory that is mapped to a package, the data model relationship of the package that is associated with the SuperCategory to the package that is associated with the SubCategory is “Package.hasChildren”. Thus, the package that is associated with the SubCategory is a child of the package that is associated with the SuperCategory. The first supercategory-subcategory mapping rule 312 is also indicated by the “3A” in the circle to the left of the relationship mapping table.

A second supercategory-subcategory mapping rule 314 specifies that if a SuperCategory is mapped to a package and that SuperCategory has a SubCategory that is mapped to an entity, the data model relationship of the package that is associated with the SuperCategory to the entity that is associated with the SubCategory is “Package.hasContents”. The second supercategory-subcategory mapping rule 314 is also indicated by the “3B” in the circle to the left of the relationship mapping table.

A third supercategory-subcategory mapping rule 316 indicates that if the SuperCategory is an entity and the SubCategory is an entity, the data model relationship of the entity that is associated with the SuperCategory to the entity that is associated with the SubCategory is Entity.hasSpecialization. Therefore, the entity that is associated with the SuperCategory is a generalization entity, and the entity that is associated with the SubCategory is a specialization entity. The third supercategory-subcategory mapping rule 316 is also indicated by the “3C” in the circle to the left of the relationship mapping table.

Referring back to FIG. 4, the fourth glossary-to-data-model mapping rule 240 will now be described. The fourth glossary-to-data-model mapping rule 240 is also indicated by the “4” in the circle to the left of the glossary-to-data-model mapping table. The fourth glossary-to-data-model mapping rule 240 is applied in response to a category containing a reference to a term in another category. For example, the “Claim Number” 44 of the “Claim Contact” category 38 of the glossary of FIG. 1 is a reference to the “Claim Number” term 46 of the “Claim” category 36. In the glossary model, a category that contains a reference to a term has a Category.referencesTerm 242 glossary model relationship. In FIG. 4, if a category has a Category.referencesTerm 242 relationship, that is, if a first category contains a reference to a term that is contained in a second category, a new attribute 244 is created and added to the entity that corresponds to the first category. The new attribute 244 is associated with the reference to the term. In addition, keys (Keys) 246 comprising a foreign key and a primary key, or if a primary key already exists then an alternate key, are created. A “hasAttribute” relationship 252 is generated to associate the primary key with the attribute that corresponds to the referenced term. Another “hasAttribute” relationship 252 is generated to associate the foreign key with the attribute that corresponds to the reference to the term. A relationship object 248 is also created to link, that is, associate, the primary and the foreign keys. In addition, for the entity that is derived from the first category, the relationship “Entity.hasKey” 250 is added to associate that entity with the foreign key. For the entity that is derived from the second category, the relationship “Entity.hasKey” 250 is added to associate that entity with the primary key.

A fifth glossary-to-data-model mapping rule 260 maps a synonym group (SynonymGroup) 262, if any, of the glossary model to the data model. The fifth glossary-to-data-model mapping rule 260 is also indicated by the “5” in the circle to the left of the glossary-to-data-model mapping table. A synonym group of a glossary identifies two or more terms that describe the same concept. When those terms are mapped to attributes in the data model, the mapping is based on an assumption that the attributes are intended to contain values that are derived from the same set of values. In a first embodiment, in the resulting data model, one of the attributes is either a primary key or an alternate key, and the other attribute is a foreign key, indicated by reference numeral 264. This is typically used in the case in which the value of a first attribute that is specified in every instance of the first entity is always identical to the value of a second attribute in some instance of the second entity. An entity can have at most one primary key. In various embodiments, the first key that is generated for an entity is designated as a primary key, and subsequent keys for that entity are designated as alternate keys. In a second embodiment, the type of the attributes is defined by a common domain 266, and a domain entity is generated. This is typically appropriate in the case where the values of the two attributes always come from the same set of possible values, but there is no constraint placed on the specific value chosen for any specific instances of the first and second attribute. In various embodiments, both the first and second embodiments are implemented. In addition, an Entity.hasKey relationship 268 is added to the entity to associate the entity with a key, and a Key.hasAttribute relationship 270 is added to associate the key(s) to the attribute(s). A relationship object 272 associates the primary and foreign keys.

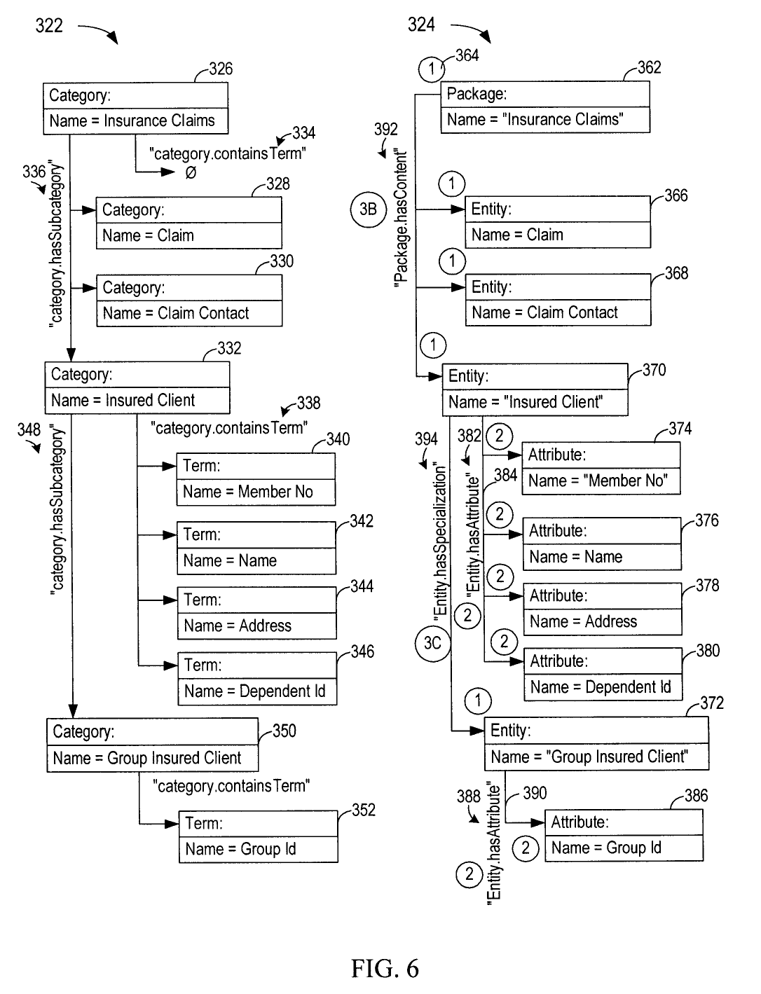

FIG. 6 depicts an exemplary mapping or transformation of a portion of an exemplary glossary model 322 representing a portion of the glossary of FIG. 1 to a portion of an exemplary data model 324. The category “Insurance Claims” 326 has the “Claim”, “Claim Contact” and “Insured Client” subcategories, 328, 330 and 332, respectively. The terms that are contained in categories 328 and 330 and the attributes that are contained in entities 366 and 368 are not shown in order to reduce the size of the diagram of FIG. 6. The processing of the objects that are contained in categories 328 and 330 is identical to the processing described below for the objects contained in category 332. As indicated by the “category.containTerms” list, that is relationship, 334 being null, the “Insurance Claims” category 326 does not contain any terms. The categories of the glossary model have a hierarchical relationship; therefore a category can have one or more subcategories. The “Insurance Claims” category 326 has a “category.hasSubcategory” list, that is, relationship, 336 that associates the “Insurance Claims” category 324 with the “Claim”, “Claim Contact” and “Insured Client” subcategories 328, 330 and 332, respectively. The “Insured Client” category 332 has a “category.containsTerms” list 338, and therefore a “category.containsTerms” relationship, comprising the “Member No”, “Name”, “Address” and “Dependent Id” terms, 340, 342, 344 and 346, respectively. The “Insured Client” category 332 also has a “category.hasSubcategory” list 348 containing the “Group Insured Client” subcategory 350. The Group Insured Client” subcategory 350 has a “category.containsTerms” list that associates the “Group Id” term 352 with the “Group Insured Client” subcategory 350.

Referring also to FIG. 4, applying the first glossary-to-data-model mapping rule 202, because the “Insurance Claims” category 326 contains subcategories but does not contain any terms (“category.containsTerms” list 334 is null), the “Insurance Claims” category 326 is mapped to a package 362, named “Insurance Claims”. In various embodiments, the package 362 is an object which is generated. In FIG. 6, the numbers in the circles refer to the associated rules of the glossary-to-data-model mapping table of FIGS. 4 and 5 which are applied. For example, the number “1” in the circle 364 refers to the rule number to the left of the glossary-to-data-model mapping table of FIG. 4.

In addition, applying the first glossary-to-data-model mapping rule 202 to the “Claim”, “Claim Contact”, “Insured Client” and “Group Insured Client” categories 328, 330, 332 and 350, the Claim”, “Claim Contact”, “Insured Client” and “Group Insured Client”, entities 366, 368, 370 and 372, respectively, are generated. In various embodiments, the entities are objects.

The second glossary-to-data-model mapping rule 204 is applied to the terms of the glossary model. The “Member No”, “Name”, “Address” and “Dependent Id” terms 340, 342, 344 and 346 are mapped to “Member No”, “Name”, “Address” and “Dependent Id” attributes 374, 376, 378 and 380 in the data model. The attributes are also objects which are generated. Because the “Insured Client” category 332 has a “category.containsTerm” list 338, comprising at least one term an “Entity.hasAttribute” relationship 382 is generated. The “Entity.hasAttribute” relationship 382 associates the “Insured Client” entity 370 with the “Member No”, “Name”, “Address” and “Dependent Id” attributes 374, 376, 378 and 380, as indicated by arrow 384.

In addition, the “Group Id” term 352 is mapped to the “Group Id” attribute 386. Because the “Group Insured Client” category 332 has a “category.containsTerm” list 338 comprising a term, an “Entity.hasAttribute” relationship 382 is generated. The “Entity.hasAttribute” relationship 382 associates the “Group Insured Client” entity 372 with the “Group Id” attribute 386, as indicated by arrow 390.

The third glossary-to-data-model mapping rule 220 is applied to the terms of the glossary model. Within the third glossary-to-data-model mapping rule 220 the rules of the relationship table of FIG. 5 are applied. The “Insurance Claims” category 326 is a supercategory and the “Claim” category 328 is a subcategory. Because the “Insurance Claims” category 326 is mapped to the “Insurance Claims” package 362 and the “Claim” category 328 is mapped to the “Claim” entity 366, the “Package.hasContents” relationship 392 is generated for the “Insurance Claims” package 362, in accordance with the second supercategory-subcategory mapping rule 314 of FIG. 5. In addition, the “Claim” entity 366 is associated as a child of the “Insurance Claims” package 362, that is, the “Insurance Claims” package contains the “Claim” entity 366. The third glossary-to-data-model mapping rule 206 is also applied to the “Claim Contact” entity 368 and the “Insured Client” entity 370 in a similar manner as the “Claim” entity 366; and therefore the “Insurance Claims” package also contains the Claim Contact” entity 368 and the “Insured Client” entity 370. Thus, the package and entities of the data model are associated in a hierarchical relationship based on the hierarchical relationship of the categories.

The “Insured Client” category 332 is a supercategory and the “Group Insured Client” category 350 is a subcategory. Because the “Insured Client” category 332 is mapped to the “Insured Client” entity 370 and the “Group Insured Client” category 350 is mapped to the “Group Insured Client” entity 372, the “Entity.hasSpecialization” relationship 394 is generated in accordance with the second supercategory-subcategory mapping rule 316 of FIG. 5. The “Entity.hasSpecialization” relationship 394 associates the “Insured Client” entity 370 with the “Group Insured Client” entity 372 such that “Group Insured Client” entity 372 is a child of the “Insured Client” entity 370.

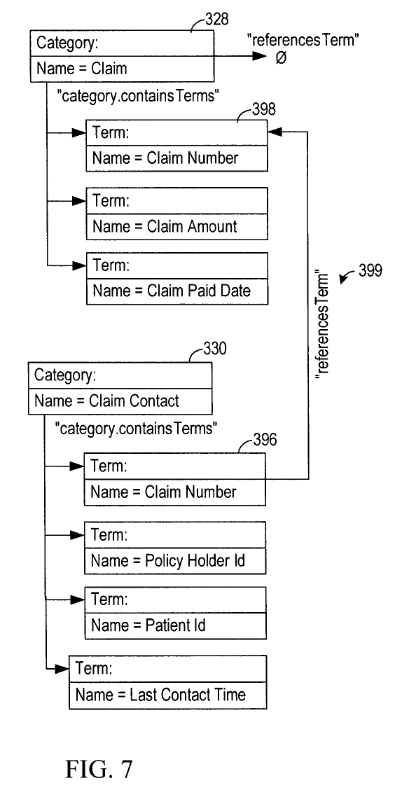

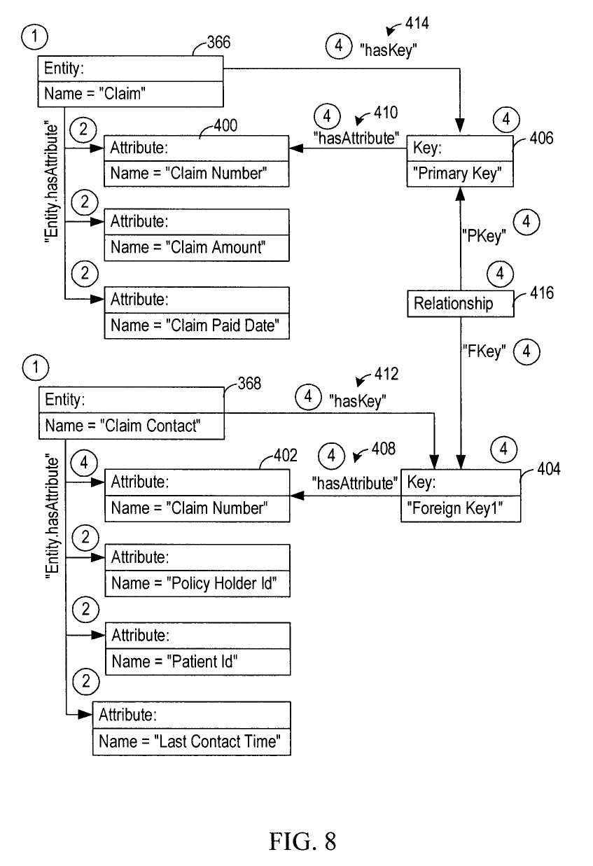

FIG. 7 depicts another portion of the exemplary glossary model representing the glossary of FIG. 1. In the glossary and glossary model, the “Claim Number” 396 of the “Claim Contact” category 330 is a reference to the “Claim Number” term 398 of the “Claim” category 328 as indicated by the “referencesTerm” relationship 399.

FIG. 8 depicts another portion of the exemplary data model which is generated based on the glossary model of FIG. 7. Because the “Claim Number” of the “Claim Contact” category is a reference to the “Claim Number” term of the “Claim” category, the fourth glossary-to-data-model mapping rule 240 is applied. The “Claim” entity 366 has a “Claim Number” attribute 400. Because the “Claim Number” term of the “Claim Contact” category references the “Claim Number” of the “Claim” category, a “Claim Number” attribute 402 is created and added to the “Claim Contact” entity 368. A foreign key 404 and primary key 406 are created and associated with the “Claim Number” attribute 402 and the “Claim Number” attribute 400 using the “has Attribute” relationship 408 and 410, respectively. A “hasKey” relationship 412 is generated to associate the “Claim Contact” entity 368 with the foreign key 404. A “hasKey” relationship 414 is generated to associate the “Claim” entity 366 with the primary key 406. A relationship object 416 is generated to link, that is, associate, the primary key 406 and the foreign key 404, and thereby indicate a relationship between the primary and foreign keys, 406 and 404, respectively.

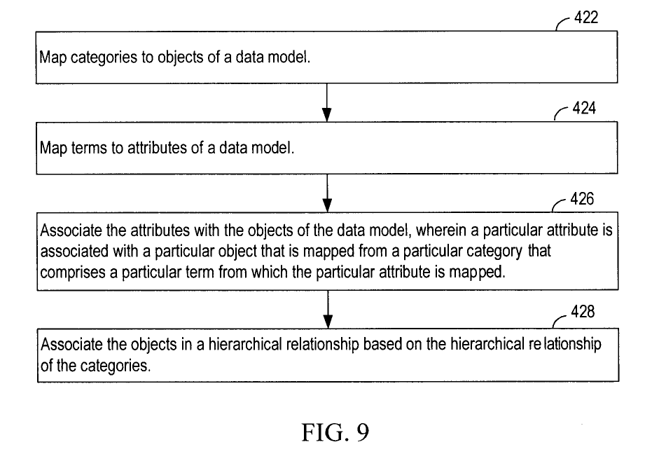

FIG. 9 depicts a flowchart of an embodiment of generating a data model from a glossary model. In various embodiments, the flowchart of FIG. 9 is implemented in the glossary-to-data-model transformation module. In step 422, the glossary-to-data-model transformation module maps categories to objects of a data model. An object may be a package or an entity. A category is mapped to a package or an entity in accordance with the rules of the glossary-to-data-model mapping table of FIG. 4. In step 424, the glossary-to-data-model transformation module maps terms to attributes of a data model. In step 426, the glossary-to-data-model transformation module associates the attributes with the objects of the data model. A particular attribute is associated with a particular object that is mapped from a particular category that comprises a particular term from which the particular attribute is mapped. In step 428, the glossary-to-data-model transformation module associates the objects in a hierarchical relationship based on the hierarchical relationship of the categories.

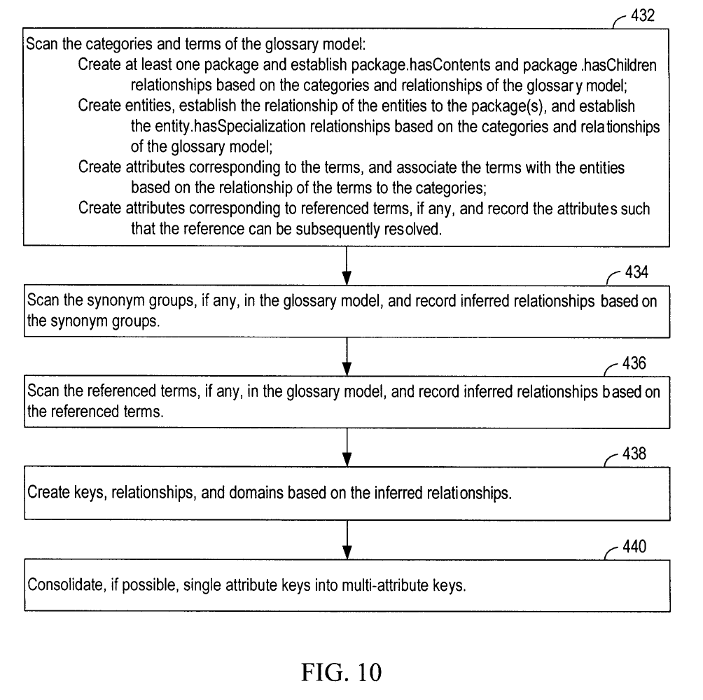

FIG. 10 depicts a flowchart of another embodiment of generating a data model from a glossary model. In various embodiments, the flowchart of FIG. 10 is implemented in the glossary-to-data-model transformation module.

In step 432, the glossary-to-data-model transformation module scans the categories and terms of the glossary model. The glossary-to-data-model transformation module creates at least one package object and establishes package.hasContents and package.hasChildren relationships based on the categories and relationships of the glossary model. In various embodiments, the glossary-to-data-model transformation module creates all package objects and establishes all package.hasContents and package.hasChildren relationships. The glossary-to-data-model transformation module creates entities, establishes the relationship of the entities to the package(s) and establishes the entity.hasSpecialization relationships based on the categories and relationships of the glossary model. The glossary-to-data-model transformation module creates attributes corresponding to the terms, and associates the terms with the entities based on the relationship of the terms to the categories. The glossary-to-data-model transformation module creates attributes corresponding to referenced terms, if any, and records the attributes such that the reference can be subsequently resolved. In various embodiments, step 432 creates packages, entities, attributes and establishes relationships in accordance with the first, second, third, and the attribute portion of the fourth glossary-to-data-model mapping rules of Table 4 and the relationship mapping table of FIG. 5. In some embodiments, step 432 implements the flowchart of FIG. 9.

In step 434, the glossary-to-data-model transformation module scans the synonym groups, if any, in the glossary model, and records inferred relationships based on the synonym groups. In various embodiments, step 434 records relationships based on the synonym groups in accordance with the fifth glossary-to-data-model mapping rule of FIG. 4. In step 436, glossary-to-data-model transformation module scans the referenced terms, if any, in the glossary model and records inferred relationships based on the referenced terms. In various embodiments, step 436 records relationships based on the synonym groups in accordance with the fourth glossary-to-data-model mapping rule of FIG. 4.

In step 438, the glossary-to-data-model transformation module creates keys, relationships, and domains based on the inferred relationships. In various embodiments, step 438 creates keys, relationships and domains in accordance with the fourth and fifth glossary-to-data-model mapping rules of FIG. 4.

In step 440, the glossary-to-data-model transformation module consolidates, if possible, single attribute keys into multi-attribute keys.

In some embodiments, in which each key consists of a single attribute, step 440 is omitted.

The consolidation of keys of step 440 will now be described in further detail. When the above processing results in n relationships between two entities where one entity is the parent entity and the other entity is the child entity, there will be n foreign keys in the child entity and n unique keys in the parent entity where each key has exactly one attribute. The phrase “unique key” refers to a key that can each uniquely identify each instance of an entity. A unique key can be either a primary key or an alternate key. If all the attributes of an entity are distinct, all the one-attribute foreign keys are combined into a single composite foreign key and all the one-attribute unique keys are combined into a single composite unique key. The two composite keys each contain n attributes.

When a single entity is a parent in relationships with different child entities, it may be further possible to consolidate the unique key(s) that are generated through the initial consolidation. In some embodiments, if two unique keys use exactly the same set of attributes, the two unique keys are combined into a single unique key that is used in more than one relationship.

For example, there are three entities C₁, C₂, and C₃ such that C₁ has Attributes: {A₁₁,A₁₂}, C₂has Attributes {A₂₁,A₂₂}, and C₃ has Attributes {A₃₁,A₃₂}. A relationship between constructs, such as entities, attributes and keys, of the data model is indicated by “x→y” where x and y are constructs. There are two relationships between entities C₁ and C₃, specifically (A₁₁)→(A₃₁) and (A₁₂)→(A₃₂) and there are two relationships between entities C₂ and C₃, specifically (A₂₁)→(A₃₁) and (A₂₂)→(A₃₂). In this example all the conditions are met to allow consolidation of these four single-attribute relationships into two distinct two-attribute relationships. The resulting relationships are: (A₁₁, A₁₂)→(A₃₁, A₃₂) and (A₂₁, A₂₂)→(A₃₁, A₃₂), where (A₁₁, A₁₂) and (A₂₁, A₂₂) are foreign keys in C₁ and C₂, respectively, and (A₃₁, A₃₂) is the primary key of C₃

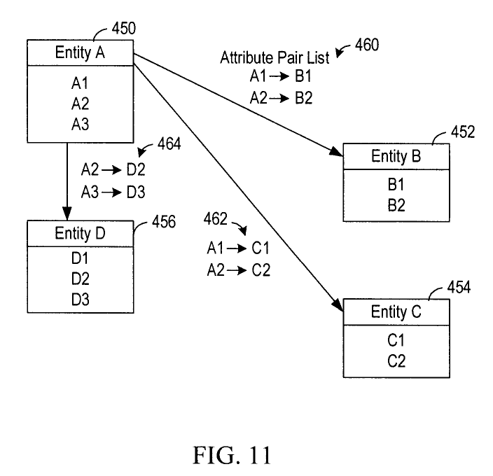

FIG. 11 illustrates four exemplary entities with their attribute pair lists. The attribute pair lists are formed based on the synonym groups. The exemplary entities are A, B, C, and D, 450, 452, 454 and 456, respectively. As indicated by attribute pair list 460, attributes A1 and A2 of Entity A 450 are derived from terms that are synonyms of the terms from which attributes B1 and B2 of Entity B 452 are derived, respectively. As indicated by attribute pair list 464, attributes A1 and A2 of Entity A 450 are derived from terms that are synonyms of the terms from which attributes C1 and C2 of Entity C 454 are derived, respectively. As indicated by attribute pair list 464, attributes A2 and A3 of Entity A 450 are derived from terms that are synonyms of the terms from which attributes D1 and D2 of Entity D 456 are derived, respectively.

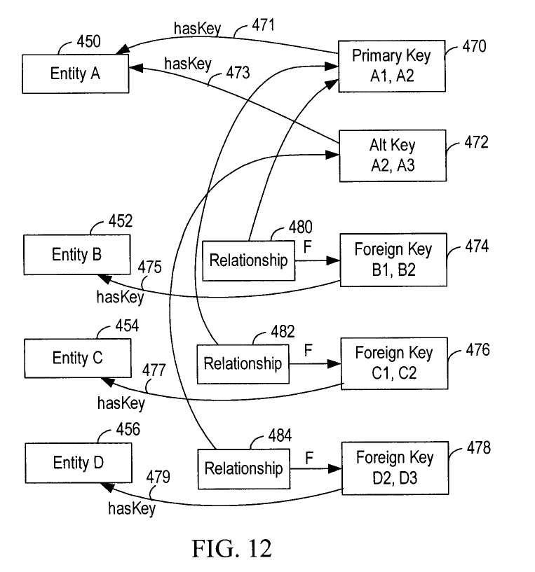

FIG. 12 depicts primary, alternate and foreign keys that are generated based on the entities and attribute pair lists of FIG. 11 in accordance with the fifth glossary-to-data-model mapping rule of FIG. 4. Entity A 450 is associated with a Primary Key 470 comprising attributes A1, A2 as indicated by the hasKey relationship 471. Entity A 450 is associated with an alternate (Alt) Key 472 comprising attributes A2, A3 as indicated by the hasKey relationship 473. Entity B 452 is associated with Foreign Key 474 comprising attributes B1, B2 as indicated by the hasKey relationship 475. Entity C 452 is associated with Foreign Key 476 comprising attributes C1, C2 as indicated by the hasKey relationship 477. Entity D 452 is associated with Foreign Key 478 comprising attributes D2, D3 as indicated by the hasKey relationship 479. Relationship object 480 is generated for Foreign Key 474 and Primary Key 470. Relationship object 482 is generated for Foreign Key 476 and Primary Key 470. Relationship object 478 is generated for Foreign Key 478 and Alternate Key 472.

Exemplary pseudo-code for generating a data model by transforming a glossary model is shown below in Tables 1, 2, 3, 4 and 5. In various embodiments, the glossary-to-data-model transformation module is implemented in accordance with the pseudo-code of Tables 1, 2, 3 4, and 5.

Table 1 contains exemplary pseudo-code called processCategory which creates Packages, Entities, and Terms of a data model based on a glossary model. In various embodiments, processCategory implements, at least in part, step 432 of the flowchart of FIG. 10.

A data structure called ModelElements is declared and has the following properties—packageChildren, packageContents and subEntities. The property called packageChildren is a list of generated Packages. The property called packageContents is a list of generated Entities. The property called subEntities is a list of generated Entities.

The inputs to processCategory comprise a parentCategory which is a Category object, and parentElements which is a ModelElements object.

TABLE 1
Exemplary pseudo-code of processCategory

```
Declare ModelElements to be a structure that contains the following properties
  packageChildren - A list of generated Packages
  packageContents - A list of generated Entities
  subEntities - A list of generated Entities
Define the method processCategory as follows
  Inputs:
    parentCategory - a Category object
    parentElements - a ModelElements object
processCategory Pseudo-code:
let nestedElements be a new instance of ModelElements
for each childCategory in the parentCategory.hasSubcategory list
  recursively invoke processCategory and pass in childCategory and nestedElements as the
    arguments
  if parentCategory does not contain or reference any Terms, but does contain one or more
    subcategories,
    Create a new Package, p.
    Add p to the parentElement.packageChildren list
    Add the nestedElements.packageChildren list to p.hasChildren
    Add the nestedElements.packageContents list to p.hasContents
    Add the nestedElements.subEntities list to the parentElement.subEntities list
  else
    Create a new Entity e.
    Add e to the parentElement.packageContents list
    Add e to the parentElement.subEntities list
    Add the nestedElements.subEntities list to e.hasChildren
    Add the nestedElements.packageChildren list to the
      parentElement.packageChildren list
    Add the nestedElements.packageContents list to the
      parentElement.packageContents list
    for each Term, t, in cat.containedTerms
      Create a new Attribute, a
      Add a to e.attributes.
    for each Term parentTerm, in cat.referencedTerms
      Create a new Attribute, childAttribute
      Add childAttribute to e.attributes.
```

The following exemplary pseudo-code has four steps. Step 1, called Process Categories implements step 432 of FIG. 10 and the first, second, third and the Attribute portion of the fourth glossary-to-data-model mapping rules of the glossary-to-data-model mapping table of FIG. 4. Step 2, called Process Synonym Groups implements step 434 of FIG. 10 and part of the single-attribute keys of the fifth glossary-to-data-model mapping rule of the glossary-to-data-model mapping table of FIG. 4. Step 3, called Process referenced Terms implements step 436 of FIG. 10, and also part of the fourth glossary-to-data-model mapping rule of the glossary-to-data-model mapping table of FIG. 4. Step 4 called Consolidate keys, implements steps 438 and 440 of FIG. 10, and part of the fourth and fifth glossary-to-data-model mapping rules of the glossary-to-data-model mapping table of FIG. 4.

TABLE 2
Exemplary pseudo-code for Step 1, Process Categories

```
// Step 1 - Process Categories
  Let rootPackage be a new instance of Package
  Let nestedElements be a new instance of ModelElements
  Fot each Category, cat
    Invoke processCategory(chlidCategory, nestedElements)
  Add the nestedElements.packageChlidren list to
  rootPackage.hasChildren
  Add the nestedElements.packageContents list to
  rootPackage.hasContents
```

The pseudo-code for step 1 of Table 2 invokes the processCategory pseudo-code of Table 1. After completion, the pseudo-code of step 1 of Table 2 proceeds to the pseudo-code of step 2 of Table 3. If there are no synonym groups, Step 2 of Table 2 is omitted and processing continues with Step 3 of Table 4.

TABLE 3
Exemplary pseudo-code for Step 2, Process Synonym Groups

```
// Step 2 - Process Synonym Groups
  Declare AttributePair to have the following properties:
    childAttribute - an Attribute that is used as the child in some Relationship object
    parentAttribute - the corresponding Attribute that is used as the parent in the same
      Relationship object
  Declare ChildToAttributeMap to be a map with the following method:
    getAttributeList(Entity childEntity) - returns a list of AttributePair objects
  Declare ParentToChildMap to be a map with the following method:
    getChildren(Entity parentEntity) - returns a ChildToAttributeMap object
  Let parentMap be a singleton instance of ParentToChildMap
  Create a new Domain, d
  For each SynonymGroup, s
  // Remember the relationships between the terms
  Let parentTerm be the s.preferredTerm (if there is no preferred term, choose the first element)
  Let parentAttribute be the Attribute previously generated from parentTerm
  Set parentAttribute.dataType to d
  Let parentEntity be the Entity that contains parentAttribute
  Let childMap be the ChildToAttributeMap from parentMap.getChildren(parentEntity)
  For each Term, childTerm, contained in S other than parentTerm
    Let childAttribute be the Attribute previously generated from childTerm
    Set parentAttribute.dataType to d
    Let childEntity be the Entity that contains childAttribute
    Let attributeList be the list of AttributePair objects from
      child Map.getAttributeList(childEntity)
    Create a new AttributePair from parentAttribute and childAttribute and add it to
      attributeList
```

The pseudo-code of Step 2 of Table 3 proceeds to the pseudo-code of Step 3 of Table 4. If there are no referenced Terms in the glossary model, Step 3 of Table 4 is omitted and processing continues to Step 4 of Table 5.

TABLE 4
Exemplary pseudo-code for Step 3, Process referenced Terms

```
// Step 3 - Process referenced Terms
  For each Entity, childEntity in the Data model
    For each parentTerm in childEntity.referencedTerms
    // Remember the relationships between the parent and child attributes
    Let childAttribute be the Attribute in childEntity that corresponds
    to parentTerm
    Let parentAttribute be the Attribute generated from parentTerm
    Let parentEntity be the Entity that contains parentAttribute
    Let childMap be the ChildToAttributeMap from
    parentMap.getChildren(parentEntity)
    Let attributeList be the list of AttributePair objects from
      childMap.getAttributeList(childEntity)
    Create a new AttributePair from parentAttribute and childAttribute
      and add it to attributeList
    // Create or reuse a Domain for the references
    If parentAttribute.dataType is already defined
      Let d be the Domain defined for parentAttribute.dataType
    Else
      Create a new Domain, d
      Set parentAttribute.dataType to d
      Set childAttribute.dataType to d
```

The pseudo-code of Step 3 of Table 4 proceeds to the pseudo-code of Step 4 of Table 5. If there are no keys, Step 4 of Table 5 is omitted.

TABLE 5
Exemplary pseudo-code for Step 4, Consolidate Keys

```
// Step 4 - Consolidate Keys
  // At this point, the singleton parentMap has entries for all the relationships that are inferred by
  // processing the SynonymGroups and the Glossary.referencedWord links. The parentMap
  // is a map from parent Entities to ChildToAttributeMap objects.
  // Each ChildToAttributeMap is a map from child Entities to a list of AttributePair objects.
  // Each AttributePair on the list is a structure that identifies a parent Attribute (from the
  // parent Entity) and the corresponding child Attribute (from the child Entity).
  // Thus each list of AttributePair objects from the ChildToAttributeMap corresponds to one
  // relationship object that will be created.
  For each (parentEntity which is the key of some entry in the parentMap)
    Let childMap be the ChildToAttributeMap from parentMap.getChildren(parentEntity)
    // Step 4.1 - go through the ChildToAttributeMap and for each parent entity, determine all the
    // distinct parent keys.
    // Also, determine which parent key to mark as the primary key based on the usage count
    // and number of attributes for each key.
    For each (ChildEntity which is the key of some entry in the childMap)
      Let attributePairList be the list of AttributePair objects from
        childMap.getAttributeList(childEntity)
      Let parentAttributeList be the list of all attribute.parentAttribute for all the
        AttributePair objects in attributePairList
      If parentAttributeList has never been seen before
      Create a new parentKey using the parent attributes from parentAttributeList
    else
      Set parentKey to be the key previously computed
      Increment the use count for the parentKey
      Remember the parentKey associated with this childEntity
      If the parentKey has a larger use count than the candidatePrimaryKey
        Set the candidatePrimaryKey to be parentKey
      Else if the parentKey has the same use count as the candidatePrimaryKey and it has a
          larger number of Attributes
        Set the candidatePrimaryKey to be parentKey
// Step 4.2 - revisit the ChildToAttributeMap and generate a Relationship object and all Keys
  For each (childEntity which is the key of some entry in the childMap)
  Let parentKey be the candidatePrimaryKey computed for the childEntity in step 4.1
  Let attributePairList be the list of AttributePair objects from
    childMap.getAttributeList(childEntity)
  Generate a new Relationship object, rel
  If the parentKey is already associated with a Key object,
    Use that Key object as the parent key for rel
  Else
    If parentKey is the candidatePrimaryKey
      Generate a PrimaryKey for the parentKey attributes
    Else
      Generate an AlternateKey for the parentKey attributes
      Use the newly generated primary/alternate Key as the parent key for rel
      Generate a ForeignKey for the child attributes in the attributeList
      Use the newly generated ForeignKey as the child key for rel
```

An example of the pseudo-code above being applied to a glossary model of the glossary of FIG. 1 will now be described.

In Step 1 of the pseudo-code of Tables 1 and 2, the categories are processed. In the Glossary model, there is one Category at the root level called “Insurance Claims”. This Category has three subcategories named “Claim”, “Claim Contact” and “Insured Client”. Also, “Insured Client” has a subcategory named “Group Insured Client”. The flow of the pseudo-code is as follows:

processCategory is invoked with the Category “Insurance Claims”

processCategory is invoked recursively with the Category “Claim”

processCategory is invoked recursively with the Category “Claim Contact”

processCategory is invoked recursively with the Category “Insured Client”

processCategory is invoked recursively with the Category “Group Insured Client”.

Since “Insurance Claims” does not contain any Terms, a Package object is generated for “Insurance Claims”. The other Categories contain Terms; therefore Entities are generated for these Categories. Entities are generated for “Claim”, “Claim Contact”, “Insured Client” and “Group Insured Client”. The Terms for each subcategory are translated into Attributes of the respective Entities.

A ModelElements object is passed into the recursive invocations of processCategory to keep track of the nesting of the Package and Entities. In this example, the end result is that the packageContents list of the “Insurance Claims” is set to {“Claim”, “Claim Contact”, “Insured Client”} and the packageChildren list of the Insurance Claims is set to null. Also, the subEntity list of Insured Client is set to {“Group Insured Client”}, while the subEntity lists of all the other Entities are set to null.

In Step 2 of the pseudo-code of Table 3, the synonym groups are processed. In this example, there are two SynonymGroups {“Policy Holder Id”, “Member No”} and {“Patient Id”, “Dependent Id”}. The flow of processing is as follows:

On the first iteration of the loop over SynonymGroups:
childMap is set to the ChildToAttributeMap from parentMap that is associated with “Insured Client”;
On the first (and only) iteration of the loop over the terms in the synonym group:
   attributeList is set to the list of AttributePair objects from childMap that is associated with “Claim Contact”;
   A new AttributePair for the Attributes Policy Holder ID and Member No is added to attributeList;

On the second iteration of the loop over synonym groups:
childMap is set to the ChildToAttributeMap from parentMap that is associated with “Insured Client”;
On the first (and only) iteration of the loop over the terms in the synonym group
   attributeList is set to the list of AttributePair objects from childMap that is associated with “Claim Contact”;
   A new AttributePair for the Attributes “Patient Id” and “Dependent Id” is added to attributeList;

In this example, both iterations of the outer loop refer to the same parent entity, but in general, this is not the typical case. Also, for cases in which the synonym groups contain more than two terms, the inner loop will have additional iterations.

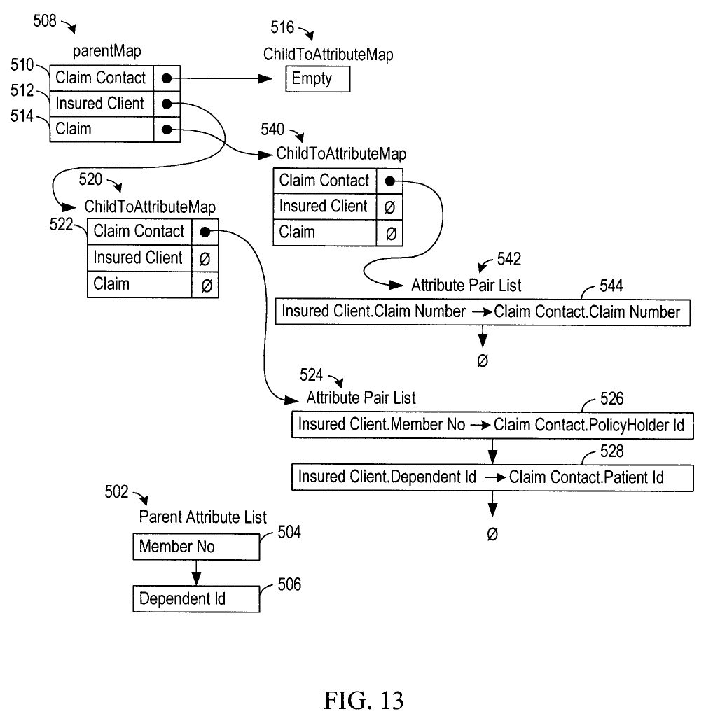

FIG. 13 illustrates various data structures which are associated with processing the synonym groups of this example. The Parent Attribute list 502 comprises “Member No” 504 and “Dependent Id” 506. The parent attributes are typically designated as being the preferred terms of a synonym group in the glossary and glossary model. In some embodiments, a synonym group has no preferred term, and the parent attribute is chosen arbitrarily. A parentMap 508 contains entries for the “Claim Contact”, “Insured Client” and the “Claim” entities, 510, 512 and 514, respectively. The “Claim Contact” entity 510 points to an empty ChildToAttributeMap 516. The “Insured Client” entity 512 points to ChildToAttributeMap 520 which through “Claim Contact” 522 references Attribute Pair List 524. The Attribute Pair List 520 has a first entry 526 that maps “Member No” of the “Insured Client” entity to the “PolicyHolder Id” of the “Claim Contact” entity and a second entry 528 that maps “Dependent Id” of the “Insured Client” entity to “Patient Id” of the “Claim Contact” entity.

In Step 3 of the pseudo-code of Table 4, the referenced terms are processed. For each entry in the relationship table, a reference is created in the data model. In this example, there is only one referenced term. The Entity “Claim Contact” references the Term “Claim Number”. On the first (and only) iteration of the loop over references: childMap is set to the ChildToAttributeMap from parentMap that is associated with the Entity named Claim; attributeList is set to the list of AttributePair objects from childMap that is associated with Claim Contact; and a new AttributePair for the Attributes “Claim Number” (in Entity “Claim”) and “Claim Number” (in Entity “Claim Contact”) is added to attributeList.

As illustrated in FIG. 13, the “Claim” entry 514 of the parentMap points to a ChildToAttributeMap 540 which points to Attribute Pair List 542 which contains an entry 544 that maps the “Claim Number” attribute of the “Claim” entity to the “Claim Number” attribute of the “Claim Contact” entity.

In Step 4 of the pseudo-code of Table 5, the keys are processed. At this point of the processing, the parentMap contains one ChildToAttributeMap object for the Entity “Insured Client” and one ChildToAttributeMap object for the Entity “Claim”. The first ChildToAttributeMap object has one AttributePair list for the Entity “Claim Contact”, which contains the pairs {(“Policy Holder Id”, “Member No”), (“Patient Id”, “Dependent Id”)}. The second ChildToAttributeMap object has one AttributePair list for the Entity “Claim Contact”, which contains the pair {(“Claim Number”, “Claim Number”)}. Thus, for this example, the outer loop over the parentMap has two iterations, and the inner loops over the childEntity objects each have one iteration.

The first inner loop attempts to consolidate parent keys and identify the primary key for each parent Entity. The example has only one parent key per parent entity; therefore in this example, there is no need to consolidate keys or to distinguish primary keys from alternate keys. This processing is performed when a given parent entity participates in two or more relationships.

Various embodiments of deriving a glossary from a data model will now be described. The content of the data model is analyzed and a glossary is generated based on a set of one or more rules that describe how various components of a data model are mapped to components of the glossary model.

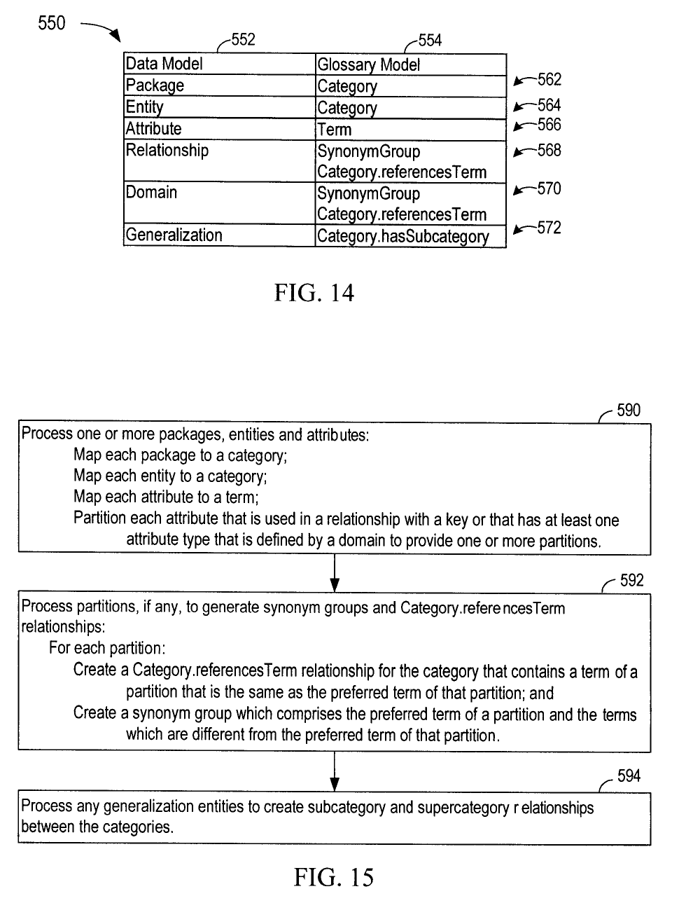

FIG. 14 depicts a data-model-to-glossary-model mapping table 550 containing rules for mapping constructs of a data model to constructs of a glossary model. In various embodiments, the rules of the data-model-to-glossary-model mapping table 550 are implemented in a data-model-to-glossary transformation module. The data-model-to-glossary-model mapping table 550 has a data model (Data Model) column 552 and a glossary model (Glossary model) column 554. A first data-model-to-glossary mapping rule 562 maps a package (Package) of a data model is mapped to a category (Category) of the glossary model. In various embodiments, a category object is created.

A second data-model-to-glossary mapping rule 564 maps an entity (Entity) of a data model to a category of the glossary model. In various embodiments, a category object is created.

A third data-model-to-glossary mapping rule 566 maps an attribute (Attribute) of a data model to a term (Term) of the glossary model. One or more attributes that are contained in a given entity are mapped to terms that are contained in the category that corresponds to the entity. In various embodiments, a term object is created for each term.

A fourth data-model-to-glossary mapping rule 568 maps a relationship object of the data model to a synonym group (Synonym Group) or to a referencesTerm indication of the glossary model. In some embodiments, a synonym group object is created. A relationship object between two classes or entities in a data model involves a pair of keys, that is a foreign key and primary key, or a foreign key and an alternate key, where each key is an ordered list of Attributes such that an instance of an Attribute from the foreign key has a value that is identical to the instance of the corresponding Attribute from the primary key, or alternately alternate key. In the case where the two terms are identical, a Category.referencesTerm relationship of the glossary model is generated. In the case where the two terms are different, both terms are determined to belong to the same SynonymGroup and a synonym group is created with those terms. These rules are based on an assumption of semantic equivalence of the two terms.

A fifth data-model-to-glossary mapping rule 570 maps a domain (Domain) of the data model to a Synonym Group or to Category.referencesTerm of the glossary model. When two attributes in the data model are defined by the same domain, that is, the attributes have a type that specifies the same domain, instances of those attributes contain values that are derived from the same set of possible values. This means that it is possible that the terms that are derived from these attributes may be semantically equivalent. This assumption of semantic equivalence is used to infer the existence of either a synonym group or a Category.referencesTerm relationship in the glossary model. In the case in which the two terms are identical, a Category.referencesTerm relationship is generated. In the case where the two terms are different, both terms are determined to belong to the same synonym group.

A sixth data-model-to-glossary mapping rule 572 maps a generalization (Generalization) of the data model to an entry on a Category.hasSubcategory list of the glossary model.

FIG. 15 depicts a flowchart of an embodiment of generating a glossary model from a data model. In various embodiments, the flowchart of FIG. 15 is implemented in the data-model-to-glossary transformation module.

In step 590, the data-model-to-glossary transformation module processes one or more packages, entities, and attributes of the data model. Each package is mapped to a category. Each entity is mapped to a category. Each attribute is mapped to a term. The name of each attribute is mapped to the name of the corresponding term. Each attribute that is used in a relationship with a key or that has at least one attribute type that is defined by a domain is partitioned to provide one or more partitions. If no attribute is used in a relationship with a key and the data model has no domains, no partition is provided. For two attributes to be related to each other, two keys are involved a primary/alternate key and a foreign key. In various embodiments, the partitioning generates one or more partitions, and each partition comprises a list of attribute names. For example, if attribute A is related to attribute B then a partition comprising the attribute names of A and B is created. If an attribute B is related to attribute D, the name of attribute C is added to the partition so that the partition comprises attribute names A, B and C. In another example if attributes F, G and H have an attribute type that is the same domain name, a partition comprising the attribute names of F, G and H is generated. The attribute names of a partition are also terms. In a partition, one attribute is designated as a primary attribute, and the term that is associated with the primary attribute is designated as a preferred term. In some embodiments, a primary attribute is based on that attribute which is part of a primary key.

In step 592, the data-model-to-glossary transformation module processes partitions, if any, to generate synonym groups and Category.referencesTerm relationships. For each partition, a Category.referencesTerm link or relationship is created for the category that contains a term of a partition that is the same as the preferred term of that partition. The Category.references term relationship is between the category that contains the term that is the same as the preferred term and the term of the category that contains the preferred term. A synonym group is created which comprises the preferred term of the partition and the terms which are different from the preferred term of that partition. For example, if a partition has terms A, B and C, and term A is the preferred term, and if terms B and C are different from term A, a synonym group is created which comprises term A, B and C.

In step 594, the data-model-to-glossary transformation module processes any generalization entities to create subcategory and supercategory relationships between the categories.

The attribute partitioning process of step 592 is used to infer the existence of synonyms and referenced terms. When two different attributes contain attribute types specify the same domain, it is likely that these attributes represent concepts that are semantically equivalent. In a data model, it is possible to explicitly specify that two attributes belong to the same domain, that is, have the same domain as the attribute type. It is also possible to infer the existence of an implicit domain if there is a relationship between two entities because the attributes that are associated with the keys that define each end of the relationship hold values that are compatible. In various embodiments, the data-model-to-glossary transformation module also identifies implicit domains based on the attributes that are associated with the keys that define each end of the relationship having values being compatible. For example, keys are determined to be compatible if the keys contain the same number of attributes and each corresponding attribute of the keys has the same data type.

When two attributes are found to belong to the same domain, regardless of whether the domain is explicitly defined in the data model or is implicitly inferred from a relationship in the data model, if the attributes have the same name, the Category.referencesTerm relationship is used to represent this semantic equivalence in the glossary model. If the attributes have different names, semantic equivalence is represented using a synonym group. In either case, the primary or preferred term is distinguished from the secondary or derived term. In the situation where there is a single relationship with single attribute keys, the attribute that is associated with the primary key is designated to map to the preferred term, while the attribute associated with the foreign key maps to the derived term.

However, this becomes complicated because a relationship may involve more than one key, and a single attribute may be referenced in more than one relationship. If a single Attribute is referenced in more than one relationship object, it is possible for the attribute to be part of a primary key in one relationship and a foreign key in some other relationship. In the case of a reflective relationship, a single attribute may be both the foreign key and the primary key of the same relationship.

The first complication is ignored by treating a relationship that contains n attributes as if it has “n” relationships, each containing a single attribute. The second complication means that a single attribute may be a foreign key in one relationship and a primary key in another. Also, an attribute may be used as a foreign key in two or more different relationships with different primary keys. Therefore, the attributes are partitioned such that if any two attributes belong to the same, implicit or explicit, domain, the attributes are grouped into the same partition.

For example, given attributes A, B, C, D, E, F, G, H, I, J, K, and H appear in the following relationships:

A→B

B→C

D→E

D→F

G→F

H→I

I→J

J→H

K→H.

The derived partitions are {A,B,C}, {D,E,F,G} and {H,I,J,K}.

Each attribute in the data model is mapped to a term in the glossary model. Each partition is mapped to either a synonym group or to a Category.referencesTerm relationship, depending on whether the names of the attributes in each partition are identical. A preferred term is chosen from each synonym group according to the following rules:
One, if there are any attributes that appear in one or more primary keys and never appear in a foreign key, count the number of times each such attribute is used in a primary key. If one of the attributes has the highest count, select that attribute as the preferred term. Otherwise, randomly select an attribute from all the attributes that have the highest count as the preferred term.
Two, if there are any attributes that appear in one or more primary keys and in one or more foreign keys, count the number of times any attribute is used in a primary key. If one of the attributes has the highest count, select that attribute as the preferred term; otherwise, randomly select an attribute from all the attributes that have the highest count as the preferred term.

In the above example, rule one indicates that C is chosen as the preferred term of the {A,B,C} group and F is chosen as the preferred term of the {D,E,F,G} group. Rule two selects H as the preferred term of the {H,I,J,K} group.

Exemplary pseudo-code that illustrates an embodiment of generating a glossary model by transforming a data model will now be described. A Partition is declared to be a list of Attributes. The Partition has following properties: attributes, primaryAttribute, parentUseCount and childUseCount. In the pseudo-code, attributes refers to the list of Attributes belonging to the Partition; primaryAttribute refers to the Attribute that has been marked as the primary key of the partition; parentUseCount(Attribute a) refers to the number of times the Attribute a is used as a parent; and childUseCount(Attribute a) refers to the number of times the Attribute a is used as a child.

Exemplary data-model-to-glossary transformation pseudo-code is illustrated below in Tables 6, 7 and 8. In various embodiments, the pseudo-code of Tables 6, 7 and 8 is implemented in a data-model-to-glossary transformation module. Table 6 comprises Step 1 of the data-model-to-glossary transformation pseudo-code which implements step 590 of FIG. 15 and the first, second and third data-model-to-glossary mapping rules 562, 564 and 566 of the data-model-to-glossary mapping table 550 of FIG. 15.

TABLE 6
Exemplary pseudo-code of Step 1 of data-model-to-glossary
transformation

```
Declare Partition to be a list of Attributes. A Partition has following properties:
  attributes - the list of Attributes belonging to the Partition
  primaryAttribute - the Attribute that has been marked as the primary key of the partition
  parentUseCount(Attribute a) - the number of times the Attribute a is used as a parent
  childUseCount(Attribute a) - the number of times the Attribute a is used as a child
// Step 1 - Create initial categories and terms, and partition the attributes that are used in
// relationships objects
For each Package, p, in the data model:
  Create a Category
For each Entity, e, in the data model
  Create a Category, cat
  Add cat to the contents of the containing Category object
  For each Attribute, a, in e,
    Create a Term, t and
    Add t to the contents of cat
    If a.dataType is defined by a Domain d
      Let p be the Partition object associated with d
      Add a to p.attributes
For each Relationship object of the form childAttribute->parentAttribute
  If neither childAttribute nor parentAttribute appear in any existing Partition
    Create a new Partition, p, and set p.attributes to contain childAttribute and
      parentAttribute
  Set p.primaryAttribute to be parentAttribute
Else if childAttribute is contained in an existing Partition, p, but parentAttribute does not
appear in any existing partitions
  add parentAttribute to p.attributes
  Increment p.childUseCount(childAttribute)
Else if parentAttribute is contained in an existing Partition, p, but childAttribute does not
appear in any existing partitions
  Add childAttribute to p.attributes
  Increment p.parentUseCount(parentAttribute)
Else if both childAttribute and parentAttribute appear in the same existing Partition, p
  Increment p.parentUseCount(parentAttribute)
  Increment p.childUseCount(childAttribute)
Else if both childAttribute appears in existing Partition pChild and parentAttribute appear
in the existing Partition, pParent
  Create a new Partition, p, by merging the contents of pParent and pChild
  Increment p.parentUseCount(parentAttribute)
  Increment p.childUseCount(childAttribute)
  Recompute p.primaryAttribute, if p is modified
```

The pseudo-code of Table 6 proceeds to the pseudo-code of Table 7. The exemplary pseudo-code of Table 7 comprises Step 2 of the data-model-to-glossary transformation pseudo-code which implements step 592 of FIG. 15 and the fourth and fifth data-model-to-glossary mapping rules 568 and 570 of the data-model-to-glossary mapping table 550 of FIG. 15.

TABLE 7
Exemplary pseudo-code of Step 2 of data-model-to-glossary
transformation

```
// Step 2 - Create Referenced Terms and/or Synonym Groups
for each Partition p
  // Convert the corresponding terms to either referenced terms or
  synonym groups based on the
  // name of each term
  Let primaryTerm be the term previously generated from
  p.primaryAttribute
  Create a SynonymGroup, synonymGroup, that contains only
  primaryTerm
  For each Attribute a in p
    If a is not p.primaryAttribute
      Let t be the Term previously generated from a
      If t.name is different from p.primaryTerm.name
        Add t to synonymGroup
      Else
        Let cat be the Category that contains t
        Remove t from cat
        Add p.primaryTerm to the cat.referencesTerm list
      If synonymGroup only has one member
        Remove the synonymGroup
```

The pseudo-code of Table 7 proceeds to the pseudo-code of Table 8. The exemplary pseudo-code of Table 8 comprises Step 3 of the data-model-to-glossary transformation pseudo-code which implements step 594 of FIG. 15 and the sixth data-model-to-glossary mapping rule 572 of the data-model-to-glossary mapping table 550 of FIG. 15.

TABLE 8
Exemplary pseudo-code of Step 3 of the data-model-to-glossary
transformation

```
// Step 3 - Convert generalizations to category nesting
For each Generalization, g, in the data model:
  Set subCat to be the category previously generated from g.subClass
  Set superCat to be the category previously generated from
  g.superClass
  Add subCat to the superCat.hasSubcategory relationship.
```

The exemplary data-model-to-glossary transformation pseudo-code will now be described with respect to the exemplary data model of FIGS. 2 and 3. In Table 6 in Step 1 of the exemplary data-model-to-glossary transformation pseudo-code initial categories and terms are created, and the attributes that appear in relationships are partitioned.

In the exemplary data model of FIGS. 2 and 3, there is one Package at the root level called Insurance Claims. This Package comprises four Entities named “Claim”, “Claim Contact”, “Insured Client”, and “Group Insured Client”. The following are performed:
Create a Category object named “Insurance Claims” from the Package of the same name;
Process the Entities contained in the “Insurance Claims” Package to create the following Categories and Terms. The categories will be subcategories of the “Insurance Claims” Category:
   Category “Claim” contains the Terms: “Claim Number”, “Claim Amount”, and “Claim Paid Date”;
   Category “Claim Contact” contains the Terms: “Claim Number”, “Policy Holder Id”, “Patient Id”, and “Last Contact Time”;
   Category “Insured Client” contains the Terms “Member No”, “Name”, “Address”, “Dependent Id”
   Category “Group Insured Client” contains the Term object “Group Id”.
Process all the Relationship objects in the data model to create the following Partition objects:
   {“Claim Contact.Claim Number”, “Claim.Claim Number”*}
   {“Claim Contact.Policy Holder Id”, “Insured Client.Member No”*}
   {“Claim Contact.Patient Id”, “Insured Client.Dependent Id”*}

In this example, each Relationship object results in a distinct Partition and each Partition has exactly two Attributes. The primaryAttribute is the Attribute that is associated with the parent Entity of the each Relationship that contributes the Attributes to the partition. In the above example, the primaryAttribute is identified with a “*”.

In general, there is not always a one-to-one relationship between the Relationship objects and the Partitions. If the source data model comprises two Relationship objects which both refer to the same Attribute, then a single Partition is created. This partition contains the shared Attribute, along with the other Attributes that are referenced by the two Relationship objects. In this case, the designation of the primaryAttribute depends on the number of times that each Attribute is used as a child key and parent key.

In Table 7 in Step 2, the exemplary data-model-to-glossary transformation pseudo-code creates referenced terms relationships and/or synonym groups based on the key attribute partition. Step 2 performs the following:
Process each Partition object to generate either a Category.referencesTerm relationship or a SynonymGroup.
For {“Claim Contact.Claim Number”, “Claim.Claim Number”*}, both Attributes have the same name, therefore a Category.referencesTerm relationship is created:
   Remove the Term “Claim Number” from the Category “Claim Contact”;
   Add the Term Claim Number to the Category.referencesTerm list associated with the Category “Claim Contact”;
For {“Claim Contact.Policy Holder Id”, “Insured Client.Member No”*}, the Attributes have the same name, therefore a SynonymGroup is created:
   Add the Terms “Policy Holder Id” and “Member No” to the new SynonymGroup;
   Select the Term “Member No” as the preferredTerm of the SynonymGroup;
For {“Claim Contact.Patient Id”, “Insured Client.Dependent Id”*}, the Attributes have the same name, therefore a SynonymGroup is created:
Add the Terms “Patient Id” and “Dependent Id” to the new SynonymGroup;
Select the Term “Dependent Id” as the preferredTerm of the SynonymGroup.

In Table 8 in Step 3, the exemplary data-model-to-glossary transformation pseudo-code converts generalizations to category nesting. This example has only one generalization. The Entity “Insured Client” is a generalization of the Entity “Group Insured Client”. Therefore, the Category “Insured Client” contains the Category “Group Insured Client”. In other words, the Category “Insured Client” is a supercategory of the subcategory “Group Insured Client”.

A glossary that is based on a glossary model may be displayed on a graphical user interface. For example, the illustrative glossary of FIG. 1 may be displayed on a graphical user interface. In addition, a data model may be displayed on a graphical user interface.

In various embodiments, the data-model-to-glossary transformation module displays, on a graphical user interface, a glossary based on the generated glossary model. In other embodiments, the data-model-to-glossary transformation module invokes another software application to display the glossary based on the glossary model. In some embodiments, the data-model-to-glossary transformation module displays, on the graphical user interface, the data model which is input on a graphical user interface. In other embodiments, the data-model-to-glossary transformation module invokes another software application to display the data model.

In some embodiments, the glossary-to-data-model transformation module displays, on a graphical user interface, a glossary based on the input glossary model. In other embodiments, the glossary-to-data-model transformation module invokes another software application to display the glossary based on the glossary model. In some embodiments, the glossary-to-data-model transformation module displays, on a graphical user interface, the data model which is generated. In other embodiments, the glossary-to-data-model transformation module invokes another software application to display the data model on a graphical user interface.

In various embodiments, a data model is generated from glossary model, the data model may be changed by the data architect, for example using a modeling tool, and subsequently a revised glossary model is generated from the data model using various embodiments of the present invention. In other embodiments, a glossary model is generated from a data model, the glossary associated with the glossary model, and therefore the glossary model, is modified by the business analyst, for example using an application familiar to the business analyst, and a data model is generated from the modified glossary model using various embodiments of the present invention. In this way, using various embodiments of the present invention, the business analyst and the data architect may use familiar tools to collaborate and implement a data model.

In various embodiments, a data model which is generated in accordance with an embodiment of the present invention is supplied to another tool which creates at least one data definition based on the data model. In some embodiments, the data definition is a schema of a database table of a relational database. In other embodiments, the data definition is an XML Schema. In various embodiments, a data modeling tool which is used by a data architect is used to generate a schema based on the data model. One example of such a tool is IBM Rational Data Architect. For example, the database administration tool creates a schema of a table based on an entity; and the names of the attributes of the entity become column names and the attribute types become the data types of the column. In some embodiments, the keys of the data model become keys of the tables of a database. In various embodiments, the data definition is an XML schema, and an XML tool creates one or more XML schemas based on the data model. The resulting data definition is a function of the particular XML tool. In other embodiments, the data definition is a COBOL copybook and a copybook tool creates a COBOL copybook based on the data model. For example, an entity may be mapped to a Group Item and an attribute may be mapped to an Elementary Item.

In other embodiments, a data model which is generated by another tool, for example, another database modeling tool, is received, and a glossary is generated based on that data model using various embodiments of the present invention.

Various embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, various embodiments of the invention can take the form of a computer program product accessible from a computer usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disk (DVD).

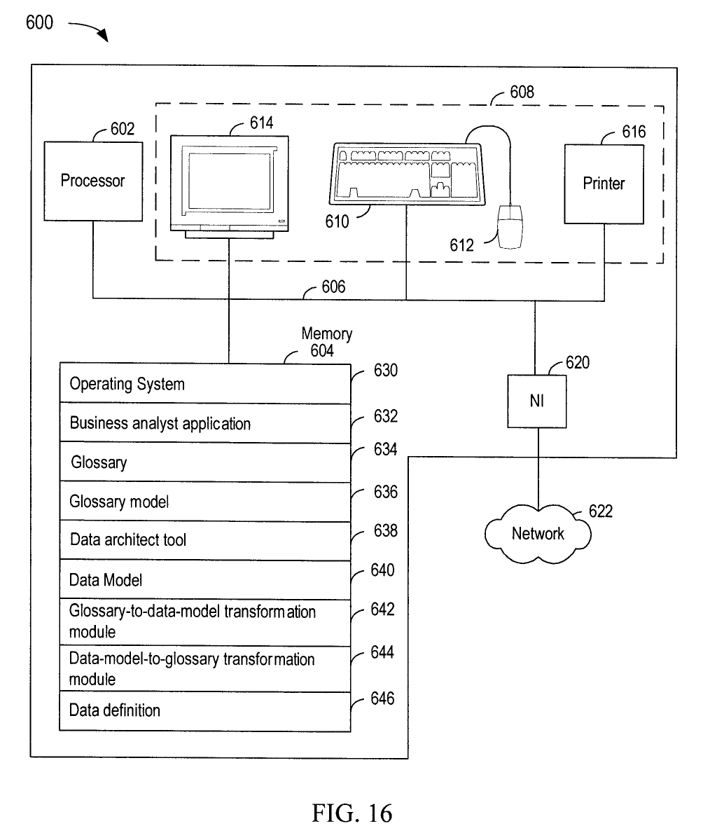

FIG. 16 depicts an illustrative data processing system 600 which uses various embodiments of the present invention. The data processing system 600 suitable for storing and/or executing program code will include at least one processor 602 coupled directly or indirectly to memory elements 604 through a system bus 606. The memory elements 604 can include local memory employed during actual execution of the program code, bulk storage, and cache memories which provide temporary storage of at least some program code in order to reduce the number of times code is retrieved from bulk storage during execution.

Input/output or I/O devices 608 (including but not limited to, for example, a keyboard 610, pointing device such as a mouse 612, a display 614, printer 616, etc.) can be coupled to the system bus 606 either directly or through intervening I/O controllers.

Network adapters, such as a network interface (NI) 620, may also be coupled to the system bus 606 to enable the data processing system to become coupled to other data processing systems or remote printers or storage devices through intervening private or public networks 622. Modems, cable modem and Ethernet cards are just a few of the currently available types of network adapters. The network adapter may be coupled to the network via a network transmission line, for example twisted pair, coaxial cable or fiber optic cable, or a wireless interface that uses a wireless transmission medium. In addition, the software in which various embodiments are implemented may be accessible through the transmission medium, for example, from a server over the network.

The memory elements 604 store an Operating system 630, Business analyst application 632, Glossary 634, Glossary model 636, Data architect tool 638, Data model 640, Glossary-to-data-model transformation module 642 and Data-model-to-glossary transformation module 644, and in some embodiments a Data definition 646 that is generated based on the Data model 640. The Business analyst application 632 may be a word processor, spreadsheet, database table(s), or glossary tool which is used to create the glossary. The Glossary model 636 is created based on the glossary 634, and in various embodiments, is a data structure that stores the glossary. The Data architect tool 638 may be a data modeling tool. In some embodiments, the Glossary-to-data-model transformation module 642 and Data-model-to-glossary transformation module 644 are implemented in a single software application. In various embodiments, the Glossary-to-data-model transformation module 642 and Data-model-to-glossary transformation module 644 are integrated with another software tool.

The Operating system 630 may be implemented by any conventional operating system such as z/OS® (Registered Trademark of International Business Machines Corporation), MVS® (Registered Trademark of International Business Machines Corporation), OS/390® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

The exemplary data processing system 600 that is illustrated in FIG. 16 is not intended to limit the present invention. Other alternative hardware environments may be used without departing from the scope of the present invention.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method, wherein a glossary model comprises categories and terms, at least one category of said glossary model comprising at least one term of said terms, said categories having a hierarchical relationship, comprising:
mapping said categories to objects of a data model;
mapping said terms to attributes of said data model;
associating said attributes with said objects of said data model, wherein a particular attribute of said attributes is associated with a particular object of said objects that is mapped from a particular category of said categories that comprises a particular term of said terms from which said particular attribute is mapped; and
associating said objects in a hierarchical relationship based on said hierarchical relationship of said categories.

2. The method of claim 1 wherein in response to a category of said categories and all direct and indirect supercategories, if any, of said category not containing any terms, said category is mapped to an object of said objects that is a package.

3. The method of claim 1 wherein in response to a category of said categories comprising at least one term, said category is mapped to an object of said objects that is an entity.

4. The method of claim 1 wherein:
in response to a category of said categories and any direct and indirect supercategories of said category not containing any terms, said category is mapped to an object of said objects that is a package; and
in response to said category comprising at least one term, said category is mapped to an object of said objects that is an entity.

5. The method of claim 1 further comprising:
in response to a first category of said categories comprising a reference to a term that is in a second category of said categories of said glossary model, wherein said first category is mapped to a first object of said objects of said data model, and said second category is mapped to a second object of said objects of said data model, generating a first key, a second key and a relationship based on said reference and said term that is in said second category, associating said first key with said first object and said second key with said second object, and associating said relationship with said first key and said second key.

6. The method of claim 1 wherein said glossary model comprises a synonym group comprising a first plurality of said terms, said first plurality of terms being associated with a first plurality of said attributes that are associated with a first plurality of said objects, respectively, further comprising:
generating at least one key based on said first plurality of terms, and associating said at least one key with said first plurality of said objects.

7. The method of claim 2 wherein said categories of said glossary model comprise a first category and a second category, said second category being a subcategory of said first category, wherein said first category is mapped to a first object of said objects, and said second category is mapped to a second object of said objects, further comprising:
in response to said first object being a package and said second object being another package, associating said first and second objects such that said second object is a child of said first object.

8. The method of claim 4 wherein said categories of said glossary model comprise a first category and a second category, said second category being a subcategory of said first category, wherein said first category is mapped to a first object of said objects, said second category is mapped to a second object of said objects, further comprising:
in response to said first object being a package, and said second object being an entity, associating said first and second objects such that said first object has a relationship with said second object such that said package contains said entity.

9. The method of claim 3 wherein said categories of said glossary model comprise a first category and a second category, said second category being a subcategory of said first category, wherein said first category is mapped to a first object of said objects, said second category is mapped to a second object of said objects, wherein said generating comprises:
in response to said first object being an entity and said second object being another entity, associating said first and second objects such that said first object is a generalization entity and said second object is a specialization entity.

10. The method of claim 1, wherein an attribute of said attributes has an attribute name and an attribute type, wherein said mapping a term of said terms to said attribute comprises setting said attribute name to said each term, further comprising:
determining said attribute type based on said attribute name matching a predetermined pattern.

11. The method of claim 1, wherein an attribute of said attributes has an attribute name and an attribute type, further comprising:
determining that said attribute type is a domain in response to said attribute being derived from a term of a synonym group.

12. The method of claim 1, further comprising:
creating at least one data definition based on at least one of said objects of said data model.

13. The method of claim 1, further comprising:
creating at least one schema of a table based on said data model, wherein said at least one schema is created based on at least one of said objects, wherein at least one column of said table is specified in said at least one schema based on said at least one attribute of said attributes.

14. A computer program product comprising a computer usable medium having computer usable program code for generating a data model based on a glossary model, said glossary model comprising categories and terms, at least one category of said glossary model comprising at least one term of said terms, said categories having a hierarchical relationship, said computer program product including:
computer usable program code for mapping said categories to objects of a data model;
computer usable program code for mapping said terms to attributes of said data model;
computer usable program code for associating said attributes with said objects of said data model, wherein a particular attribute of said attributes is associated with a particular object of said objects that is mapped from a particular category of said categories that comprises a particular term of said terms from which said particular attribute is mapped; and
computer usable program code for associating said objects in a hierarchical relationship based on said hierarchical relationship of said categories.

15. The computer program product of claim 14 wherein said computer usable program code for mapping said categories, in response to a category of said categories and all direct and indirect supercategories, if any, of said category not containing any terms, maps said category to an object of said objects that is a package.

16. The computer program product of claim 14 wherein said computer usable program code for mapping said categories, in response to a category of said categories comprising at least one term, maps said category to an object of said objects that is an entity.

17. The computer program product of claim 14 wherein said computer usable program code for mapping said categories, in response to a category of said categories and any direct and indirect supercategories of said category not containing any terms, maps said category to an object of said objects that is a package; and in response to said category comprising at least one term, maps said category to an object of said objects that is an entity.

18. The computer program product of claim 14 further comprising:
computer usable program code for, in response to a first category of said categories comprising a reference to a term that is in a second category of said categories of said glossary model, wherein said first category is mapped to a first object of said objects of said data model, and said second category is mapped to a second object of said objects of said data model, generating a first key, a second key and a relationship based on said reference and said term that is in said second category, associating said first key with said first object and said second key with said second object, and associating said relationship with said first key and said second key.

19. The computer program product of claim 14, further comprising:
computer usable program code for generating at least one key based on a plurality of terms of a synonym group of said glossary model, and associating said at least one key with a plurality of said objects that are associated with attributes that are mapped from said plurality of terms of said synonym group.

20. The computer program product of claim 15, further comprising:
computer usable program code for, in response to a first object of said objects being a package, and a second object of said objects being another package, wherein a category of said categories from which said second object is mapped is a subcategory of a category of said categories from which said first object is mapped, associating said first and second objects such that said second object is a child of said first object.

21. The computer program product of claim 17, further comprising:
computer usable program code for, in response to a first object of said objects being said package and a second object of said objects being said entity, wherein a category of said categories from which said second object is mapped is a subcategory of a category of said categories from which said first object is mapped, associating said first and second objects such that said first object has a relationship with said second object such that said package contains said entity.

22. The computer program product of claim 14 wherein each attribute of said attributes has an attribute name and an attribute type, wherein said mapping said terms to said attributes of said data model comprises setting said attribute name to a respective term of said terms, further comprising:
computer usable program code for determining said attribute type based on said attribute name matching a predetermined pattern.

23. A computer-implemented method of generating a glossary based on a data model, said data model comprising objects and attributes, said attributes being associated with said objects, said objects having a hierarchical relationship, comprising:
mapping said objects to categories;
mapping said attributes to terms;
associating said categories in a hierarchical relationship based on said hierarchical relationship of said objects;
associating each term of said terms with at least one category of said categories based on said at least one object of said objects from which said at least one category is mapped comprising said attribute from which said term is mapped.

24. The method of claim 23, wherein said objects of said data model comprise at least one package and a plurality of entities.

25. The method of claim 23 wherein said data model comprises at least one key, further comprising:
determining that a first term of said terms is a synonym of a second term of said terms based on said at least one key; and
generating a synonym group comprising said first term and said second term.

26. The method of claim 23 wherein said data model comprises a first attribute of said attributes that is associated with a primary key, a second attribute of said attributes that is associated with a foreign key, further comprising:
in response to a first attribute and a second attribute of said attributes having different names, generating a synonym group comprising a first term based on said first attribute and a second term based on said second attribute.

27. The method of claim 23 wherein said data model comprises a first attribute of said attributes that is associated with a primary key, a second attribute of said attributes that is associated with a foreign key, further comprising:
in response to a first attribute and a second attribute of said attributes having same names, generating a reference to a first term that is associated with said first attribute for a category that is associated with an entity comprising said second attribute.

28. The method of claim 23 wherein said data model comprises a domain, further comprising:
in response to a first attribute and a second attribute of said attributes being associated with said domain, generating a synonym group comprising a first term based on said first attribute and a second term based on said second attribute in response to said first term and said second term being different.

29. The method of claim 23 wherein said data model comprises a domain, further comprising:
in response to a first attribute and a second attribute of said attributes being associated with said domain, generating a reference to a first term that is associated with said first attribute for a category that is associated with an entity comprising said second attribute in response to said first term and second term being the same.

30. The method of claim 23 wherein said objects of said data model comprise a generalization entity and a specialization entity,
wherein said mapping said objects maps said generalization entity to a first category of said glossary model;
wherein said mapping said objects maps said specialization entity to a second category of said glossary model; and further comprising:
associating said first and second categories such that said second category is a subcategory of said first category.
